(19) United States
(12) Patent Application Publication
(10) Pub. No.: US 2016/0052146 A1
(43) Pub. Date: Feb. 25, 2016

(54) ROBOTIC TOOL CHANGER WITH TOOL STAND DECOUPLE POWER SUPPLY

(71) Applicant: ATI Industrial Automation, Inc., Apex, NC (US)

(72) Inventors: William G. Berrocal, Holly Springs, NC (US); Mack Earl Manning, Apex, NC (US)

(21) Appl. No.: 14/749,708

(22) Filed: Jun. 25, 2015

Related U.S. Application Data
(60) Provisional application No. 62/067,200, filed on Oct. 22, 2014.
(60) Provisional application No. 62/039,848, filed on Aug. 20, 2014.

(51) Int. Cl. B25J 15/04; B23Q 3/155; B23B 31/30

(52) U.S. Cl. CPC B25J 15/0441; B23B 31/30; B23Q 3/1552

(57) ABSTRACT

A robotic tool changer ensures inherently safe operation by separating power sources for the “couple” and “decouple” operations of its coupling mechanism. The power for the decouple operation is available only when an attached robotic tool is safely disposed in its tool stand. Once the robotic tool leaves the tool stand, there is no power supplied to the coupling mechanism of the robotic tool changer to decouple the robotic tool from a robot arm. Accordingly, it is impossible for the robotic tool to inadvertently become disengaged from the robot arm—even if software were to erroneously assert a DECOUPLE signal, or otherwise initiate a decouple operation. Furthermore, since the design is inherently safe, neither interlock circuits, the redundancy of such circuits, nor the extensive and complex monitoring circuits necessary to ensure their proper operation, are necessary.

### RELATED APPLICATIONS

This application claims priority to U.S. Provisional Patent Application Ser. Nos. 62/039,848, filed Aug. 20, 2014, and 62/067,200, filed Oct. 22, 2014, the disclosures of which are incorporated by reference herein, in their entireties.

### FIELD OF INVENTION

The present invention relates generally to robotics, and in particular to an inherently safe robotic tool changer receiving power to decouple from a tool stand.

### BACKGROUND

Industrial robots have become an indispensable part of modern manufacturing. Whether transferring semiconductor wafers from one process chamber to another in a cleanroom or cutting and welding steel on the floor of an automobile manufacturing plant, robots perform many manufacturing tasks tirelessly, in hostile environments, and with high precision and repeatability.

In many robotic manufacturing applications, it is cost-effective to utilize a relatively generic robot arm to accomplish a variety of tasks. For example, in an automotive manufacturing application, a robot arm may be utilized to cut, grind, or otherwise shape metal parts during one phase of production, and perform a variety of welding tasks in another. Different welding tool geometries may be advantageously mated to a particular robot arm to perform welding tasks at different locations or in different orientations.

In these applications, a tool changer is used to mate different robotic tools to the robot. One half of the tool changer, called the master unit, is permanently affixed to a robot arm. The other half, called the tool unit, is affixed to each robotic tool that the robot may utilize. The various robotic tools a robot may utilize are typically stored, within the range of motion of the robot arm, in tool stands which are sized and shaped to hold each tool securely when not in use. When the robot arm positions the master unit, on the end of the robot arm, adjacent to a tool unit connected to a desired robotic tool sitting in a tool stand, a coupling mechanism is actuated that mechanically locks the master and tool units together, thus affixing the robotic tool to the end of the robot arm. The tool changer thus provides a consistent mechanical interface between a robot arm and a variety of robotic tools. A tool changer may also pass utilities to a robotic tool.

Robotic tools may require utilities, such as electrical current, air pressure, hydraulic fluid, cooling water, electronic or optical data signals, and the like, for operation. When numerous different tools—requiring different utilities—are utilized by the same robot, the utility connections must be manually established each time a tool is changed. To eliminate this procedure, one important function of a robotic tool changer is to provide utility-passing modules. Such modules may be attached to standardized locations on the master and tool units of the robotic tool changer. The modules include mating terminals, valve connections, electrical connectors, and the like, making the utilities available to the selected tool when it is coupled to the robot arm. Many tool changers include one or more standard-sized “ledges” about their periphery, to which various utility-passing modules may be attached, as required. Tool changers and utility-passing modules are well known in the robotics arts, and are commercially available, such as from the assignee, ATI Industrial Automation of Apex, N.C.

As mentioned above, when not in use, each robotic tool is stored in a special rack, or tool stand, within the operative range of the robotic arm. Robot arm controller software “remembers” where each robotic tool is, and each robotic tool is returned to precisely the same position in its tool holder prior to the tool changer decoupling. Similarly, the robot arm controller software “knows” precisely where the next desired robotic tool is stored, and it positions the master unit of the tool changer (on the robot arm) adjacent the tool unit (on the desired robotic tool), and then actuates the tool changer to couple the next robotic tool to the robot arm.

Safety is a paramount concern in manufacturing environments. A variety of workplace regulations govern the use of large industrial robots, with heavy robotic tools attached thereto. For example, ISO 13849, “Safety of machinery—Safety related parts of control systems,” defines five Performance Levels (PL), denoted A through E. Performance Level D (PLD), mandated for many industrial robotics applications, requires a probability of less than 10⁶ dangerous failures per hour—that is, at least a million hours of operation between dangerous failures.

The most likely dangerous failure, from the perspective of a robotic tool changer and its functionality, is an inadvertent decoupling of the master and tool units, allowing a robotic tool to fall free from the robot arm. This danger has long been recognized, and state-of-the-art robotic tool changer design minimizes the risk. For example, in the event positive coupling power, such as pneumatic pressure, is lost during operation, “failsafe” designs ensure that a tool will not separate from the robot arm. See, e.g., U.S. Pat. Nos. 7,252,453 and 8,005,570, assigned to ATI Industrial Automation, the assignee of the present application.

Besides preventing accidental robotic tool drops resulting from loss of pressure, ATI Industrial Automation has also addressed the safety hazard of software bugs or inadvertent commands presenting a valid “decouple” command to a robotic tool changer at the wrong time, such as when a tool is in use. U.S. Pat. No. 6,840,895 describes an interlock circuit that precludes even a valid “uncouple” command from reaching a coupling mechanism of a robotic tool changer if a tool side safety interlock is not engaged. The tool side safety interlock is automatically engaged whenever the robotic tool is placed in its tool stand, and is disengaged whenever the robotic tool is removed from the tool stand.

Interlock circuits can effectively prevent inadvertent decoupling of a robotic tool changer. However, to meet very stringent safety standards, such as ISO 13849 PLD, critical elements (circuit components, pneumatic valves, and the like) must be redundant. Furthermore, to ensure that the designed redundancy is not illusory, such as if one of the redundant circuits were to fail, monitoring means must be added that constantly ensure all critical elements are not only present, but are fully operational and functional. Such redundancy and monitoring systems add cost, complexity, and weight to a robotic tool changer.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, a robotic tool changer ensures inherently safe operation by separating power sources for the “couple” and “decouple” operations of its coupling mechanism. The power for the decouple operation is available only when the attached robotic tool is safely disposed in its tool stand. Once the robotic tool leaves the tool stand, there is no power supplied to the coupling mechanism of the robotic tool changer to decouple the robotic tool from the robot arm. Accordingly, it is impossible for the robotic tool to inadvertently become disengaged from the robot arm—even if software were to erroneously assert a DECOUPLE signal, or otherwise initiate a decouple operation. Furthermore, since the design is inherently safe, neither interlock circuits, the redundancy of such circuits, nor the extensive and complex monitoring circuits necessary to ensure their proper operation, are necessary.

One embodiment relates to a robotic tool changer. The robotic tool changer includes a master unit assembly operative to connect to a robot, and a tool unit assembly operative to connect to a robotic tool. A coupling mechanism is disposed in one of the master and tool unit assemblies, and it is operative to selectively couple the master and tool unit assemblies together. The coupling mechanism requires a first source of power to couple and a separate, second source of power to decouple. The robotic tool changer receives the second power only from a tool stand operative to safely hold the robotic tool. Hence, the decouple power is only available when an attached robotic tool is safely disposed in its tool stand.

Another embodiment relates to an inherently safe method of selectively attaching a robotic tool disposed in a tool stand to a robot. A master unit assembly of a tool changer is attached to the robot and a tool unit assembly of the tool changer attached to the robotic tool. One of the master and tool unit assemblies includes a coupling mechanism operative to selectively couple and decouple the master and tool unit assemblies to and from each other. The robot is positioned adjacent the robotic tool such that the master and tool unit assemblies abut. Power from a first source is utilized to drive the coupling mechanism to couple the master and tool unit assemblies together. The robotic tool is removed from the tool stand by operation of the robot. The robotic tool is returned to the tool stand by operation of the robot. Power from a second source associated with the tool stand is utilized to drive the coupling mechanism to decouple the master and tool unit assemblies. When the robotic tool is not disposed in the tool stand, no power from the second source is available to drive the coupling mechanism to decouple the master and tool unit assemblies.

In some embodiments, the coupling mechanism comprises a pneumatically-actuated piston, for example, operating similarly to those described in U.S. Pat. Nos. 7,252,453 and 8,005,570. The piston has a couple port to receive pneumatic fluid from a first supply operative to move the piston so as to couple the master and tool units together. The term “forward” is used herein to describe motion of the piston in a direction to couple the master and tool units. The space behind the piston, into which the couple port directs pneumatic fluid, is referred to herein as a couple chamber.

The piston has a separate decouple port to receive pneumatic fluid from a separate supply, different from the first supply (or at least flowing to the piston along a different path). Pneumatic fluid at the decouple port is operative to move the piston so as to decouple the master and tool units from each other. The term “backward” is used herein to describe motion of the piston in a direction to decouple the master and tool units. The space in front of the piston, into which the decouple port directs pneumatic fluid, is referred to herein as a decouple chamber. The pneumatic fluid for the decouple port flows to the robotic tool changer only from the tool stand, through a pneumatic coupling on or attached to the tool unit that mates with a corresponding pneumatic coupling on the tool stand when an attached robotic tool is safely disposed in the tool stand.

When the robotic tool is attached to the robot arm and is removed from its tool stand, there is no pneumatic pressure available at the decouple port to move the piston backward, to decouple the tool unit from the master unit. Hence, the robotic tool changer of embodiments of the present invention is inherently safe from inadvertent decoupling of a robotic tool from the robot arm unless the robotic tool is disposed in its tool stand. In various embodiments, the control of flow of pneumatic fluid—e.g., via valves and pneumatic flow-through conduits—is distributed in various ways, each of which has particular advantages regarding cost, complexity, ease of maintenance, and the like. However, all embodiments share the design feature that an attached robotic tool must be disposed in its tool stand to enable the robotic tool changer to decouple the tool unit from the master unit (and hence remove the robotic tool from the robot arm).

A number of different embodiments described and claimed herein all share the feature of inherent safety by having pneumatic fluid required to decouple the tool changer supplied by or routed through a tool stand, such that it is only available when the robotic tool is disposed in the tool stand.

In a first embodiment, the tool stand supplies pneumatic fluid, a decouple control valve is associated with the tool unit, and a couple control valve is associated with the master unit.

In a second embodiment, the tool stand supplies pneumatic fluid, and a decouple control valve is associated with the tool stand, receiving control signals from the robot.

In a third embodiment, a single robot pneumatic fluid supply provides pneumatic fluid for both coupling and decoupling. The decoupling pneumatic fluid is routed through the tool unit to a bridge on the tool stand, and back through the tool unit to the master unit (and is hence unavailable unless the robotic tool is disposed in the tool stand).

In a fourth embodiment, the tool stand supplies pneumatic fluid, and a decouple control valve is associated with the tool stand, receiving control signals from the robot. The robot also supplies pneumatic fluid, and a couple control valve is associated with the robot. Both the matter and tool units provide pneumatic fluid pass-through.

In a fifth embodiment, the tool stand supplies pneumatic fluid at a first pressure. There is no decouple control valve. The robot supplies pneumatic fluid at a second pressure higher than the first pressure, and a couple control valve is associated with the master unit.

The couple control valve in the first through fifth embodiments, and the decouple control valve in the first through fourth embodiments, are preferably 3-way solenoid valves. In a sixth embodiment, a single, 4-way solenoid control valve controls pneumatic fluid flow for both couple and decouple operations. As in the third embodiment, pneumatic fluid is routed through the tool stand, and is hence unavailable for decouple operation when an attached robotic tool is removed from the tool stand.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a perspective view of a tool changer.

FIG. 2 is a perspective view of a master unit pneumatic module.

FIG. 3 is a perspective view of a tool unit pneumatic module, depicting a valve inside.

FIG. 4A is a pneumatic schematic diagram of the tool side of a tool changer in a tool stand, according to a first embodiment.

FIG. 4B is a pneumatic schematic diagram of a tool changer depicting a couple operation, according to a first embodiment.

FIG. 4C is a pneumatic schematic diagram of a tool changer depicting a decouple operation, according to a first embodiment.

FIG. 4D is a pneumatic schematic diagram of a tool changer when the master and tool units are separated, according to a first embodiment.

FIG. 5A is a pneumatic schematic diagram of the tool side of a tool changer in a tool stand during a couple operation, according to a second embodiment.

FIG. 5B is a pneumatic schematic diagram of a tool changer depicting a couple operation, according to a second embodiment.

FIG. 5C is a perspective view of a tool unit pneumatic module, depicting a pneumatic pass-through conduit inside.

FIG. 5D is a pneumatic schematic diagram of the tool side of a tool changer in a tool stand during a decouple operation, according to a second embodiment.

FIG. 5E is a pneumatic schematic diagram of a tool changer depicting a decouple operation, according to a second embodiment.

FIG. 6A is a pneumatic schematic diagram of the tool side of a tool changer in a tool stand, according to a third embodiment.

FIG. 6B is a perspective view of a tool unit attachment, according to a third embodiment.

FIG. 6C is a perspective view of a tool stand attachment including a bridge conduit, according to a third embodiment.

FIG. 6D is a perspective view of the attachments of FIGS. 6B and 6C mounted on a tool stand, according to a third embodiment.

FIG. 6E is a pneumatic schematic diagram of a tool changer depicting a couple operation, according to a third embodiment.

FIG. 6F is a pneumatic schematic diagram of a tool changer depicting a decouple operation, according to a third embodiment.

FIG. 7A is a pneumatic schematic diagram of the tool side of a tool changer in a tool stand during a couple operation, according to a fourth embodiment.

FIG. 7B is a pneumatic schematic diagram of a tool changer depicting a couple operation, according to a fourth embodiment.

FIG. 7C is a pneumatic schematic diagram of the tool side of a tool changer in a tool stand during a decouple operation, according to a fourth embodiment.

FIG. 7D is a pneumatic schematic diagram of a tool changer depicting a decouple operation, according to a fourth embodiment.

FIG. 8A is a pneumatic schematic diagram of the tool side of a tool changer in a tool stand, according to a fifth embodiment.

FIG. 8B is a pneumatic schematic diagram of a tool changer depicting a couple operation, according to a fifth embodiment.

FIG. 8C is a pneumatic schematic diagram of a tool changer depicting a decouple operation, according to a fifth embodiment.

FIG. 8D is a pneumatic schematic diagram of a tool changer when the master and tool units are separated, according to a fifth embodiment.

FIG. 9A is a pneumatic schematic diagram of the tool side of a tool changer in a tool stand, according to a sixth embodiment.

FIG. 9B is a pneumatic schematic diagram of a tool changer depicting a couple operation, according to a sixth embodiment.

FIG. 9C is a pneumatic schematic diagram of a tool changer depicting a decouple operation, according to a sixth embodiment.

FIG. 9D is a pneumatic schematic diagram of a tool changer when a robotic tool is removed from the tool stand, according to a sixth embodiment.

FIG. 10 is a flow diagram of an inherently safe method of attaching a robotic tool to a robot.

### DETAILED DESCRIPTION

For simplicity and illustrative purposes, the present invention is described by referring mainly to exemplary embodiments thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure embodiments of the present invention.

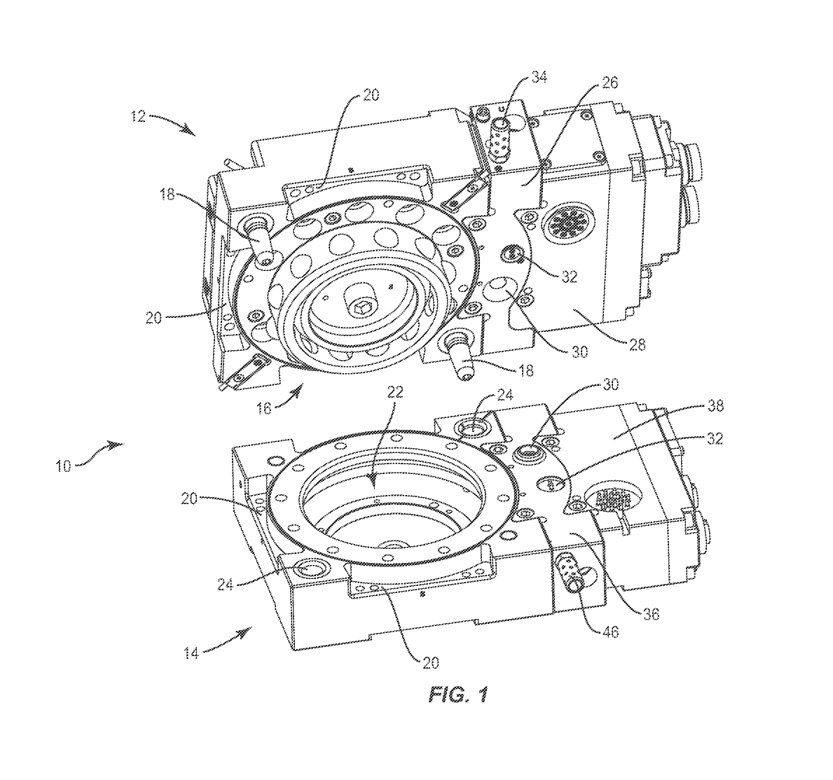

FIG. 1 depicts one embodiment of a robotic tool changer 10. The tool changer 10 comprises a master unit 12 operative to be affixed to a robot arm (not shown), and a tool unit 14 operative to be affixed to a robotic tool (not shown). The master unit 12 includes a coupling mechanism 16 which projects from a front surface thereof, conical alignment pins 18, and a ledge 20 formed on each of four sides for the attachment of utility-passing modules. The tool unit 14 includes a recess 22 to accept the coupling mechanism 16, and tapered alignment holes 24 to accept alignment pins 18. The tool unit 14 also includes a ledge 20 formed on each of four sides for the attachment of utility-passing modules.

The coupling mechanism 16, disposed in the master unit 12 in the embodiment pictured, operates by projecting balls radially outward through concentrically spaced holes. When the master unit 12 is in contact with the tool unit 14 such that the coupling mechanism 16 is disposed within the recess 22, the balls contact and are pressed against an annular surface within the recess 22 in the tool unit 14, thus coupling the master unit 12 and tool unit 14 together. The balls are urged outwardly by angled cam surfaces of a pneumatically-actuated piston. As the piston moves along a longitudinal axis in a forward direction toward the tool unit, the balls are pushed outwardly and into contact with the annular surface in the tool unit 14. To decouple the master 12 and tool 14 units, the piston is retracted along the longitudinal axis in a backward direction (away from the tool unit). The angled cam surfaces then disengage the balls, allowing them to retract into holes and allow the master 12 and tool 14 units to disengage and be separated. Greater detail of robotic tool changer pneumatically-actuated coupling mechanisms may be found in U.S. Pat. Nos. 7,252,453 and 8,005,570.

The movement of the piston is of primary concern from a safety perspective. According, the piston is designed and implemented to require separate power sources (in this case, pressurized pneumatic fluid supplies) to drive the piston along each direction—that is, to couple and to decouple the master unit 12 and tool unit 14. Furthermore, in some embodiments, the actuation of pneumatic valves controlling pneumatic fluid flow on each side of the piston drive mechanism must be coordinated. For example, in the coupled state, pressurized air is maintained in the couple chamber (behind the piston), forcing the piston to its maximum extent along the longitudinal axis in the forward direction. During this time, the decouple chamber of the piston is open to ambient air pressure. To then decouple the tool changer 10, not only must pneumatic fluid be applied through the decouple port to the decouple chamber (front side of the piston), to drive the piston along the longitudinal axis in a backward direction, but also the couple chamber formed at the back of the piston must be vented to ambient air pressure, to allow the piston to retract.

Similarly, to again couple the master unit 12 to the same or a different tool 14, pneumatic fluid is applied to the couple port, applying pressurized air to the couple chamber to drive the piston forward, and also pressure in the decouple chamber must be relieved, to allow the piston to move forward. Thus, a three-way pneumatic valve is required to supply pneumatic fluid to each port of the piston, in addition to the ports being supplied by separate pneumatic fluid supplies (or pneumatic fluid flow routes).

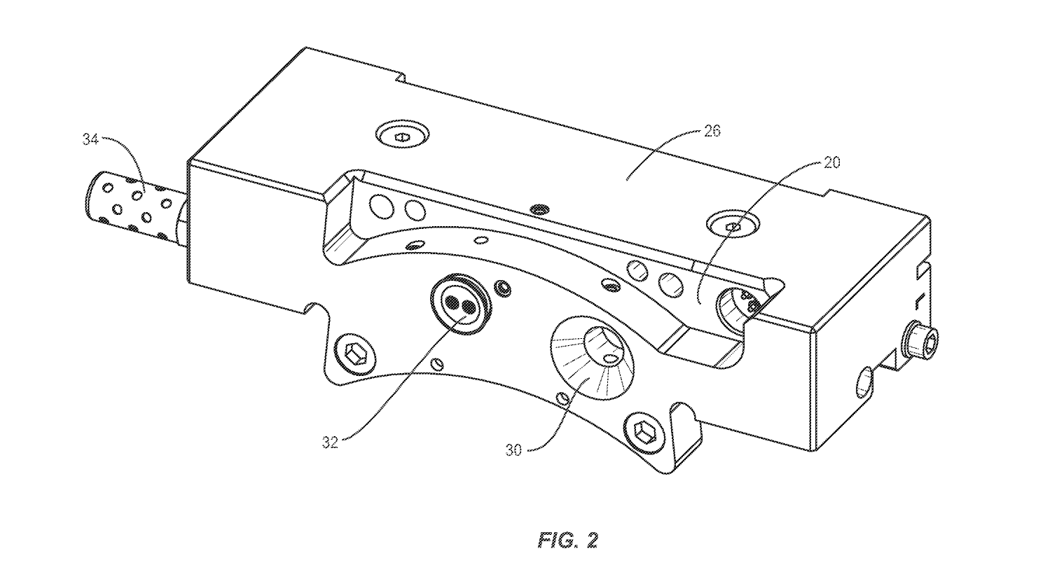

In some embodiments described herein, affixed to one ledge 20 of the master unit 12 is a master unit pneumatic module 26. The master unit pneumatic module 26 itself includes a mounting ledge 20 opposite the master unit 12, allowing a utility-passing module 28 to be attached thereto. The master unit pneumatic module 26 thus provides the inherently safe coupling mechanism 16 actuation according to embodiments of the present invention, without diminishing the utility-passing module capacity of the tool changer 10. In other embodiments (not shown), the functionality of the master unit pneumatic module 26 may be built into the master unit 12, without requiring an external module 26. FIG. 2 depicts a stand-alone view of the master unit pneumatic module 26.

The master unit pneumatic module 26 includes a pneumatic coupling port 30. This coupling port 30 is positioned so as to mate with a corresponding pneumatic coupling port on a tool unit pneumatic module 36 when the modules 26, 36 abut. The pneumatic coupling 30 passes pneumatic fluid supplied by or through a tool stand to the tool unit pneumatic module 36 when an attached tool is disposed in the tool stand. Internal to the master unit pneumatic module 26, a pneumatic flow-through conduit (not shown) connects the pneumatic coupling port 30 in pneumatic fluid flow relationship to a decouple port of a pneumatically-actuated piston 56 of the coupling mechanism 16. In some embodiments, the master unit pneumatic module 26 includes an electrical connector 32, positioned so as to mate with a corresponding electrical connector on some embodiments of the tool unit pneumatic module 36. In these embodiment, the electrical connector 32 transfers at least a DECOUPLE command to the tool unit pneumatic module 36. The master unit pneumatic module 26 may further include a pneumatic fluid connector 34, operative to be connected to a pneumatic fluid supply on a robot arm.

In most embodiments disclosed herein, the master unit pneumatic module 26 includes a 3-way solenoid valve (not shown in FIG. 2), referred to herein as the couple control valve. The couple control valve is operative to control the supply of pneumatic fluid from the robot (via the pneumatic fluid connector 34) to the couple port of the pneumatically-actuated piston 56 of the coupling mechanism 16 during coupling operation, and also to vent air from the couple chamber of the piston 56 during decouple operation. The master unit pneumatic module 26 also includes the above-described pneumatic flow-through conduit (not shown) connecting the pneumatic coupling port 30 (which receives pneumatic fluid via the tool unit pneumatic module 36 from the tool stand 48) to the decouple port of the pneumatically-actuated piston of the coupling mechanism 16.

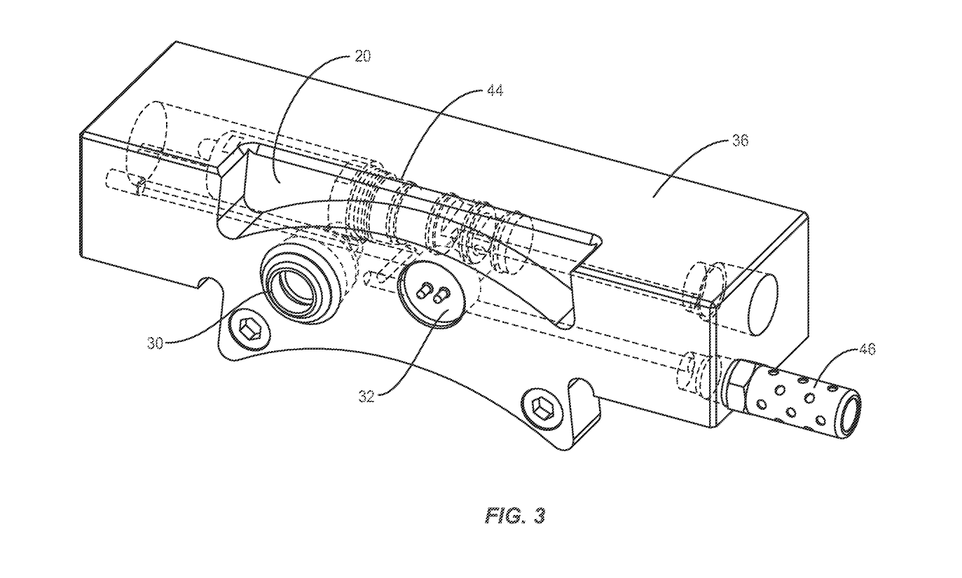

As depicted in FIG. 1, affixed to one ledge 20 of the tool unit 14 is a tool unit pneumatic module 36. The tool unit pneumatic module 36 itself includes a mounting ledge 20 opposite the tool unit 12, allowing a utility-passing module 38 to be attached thereto. The tool unit pneumatic module 36 thus provides the inherently safe coupling mechanism 16 actuation according to embodiments of the present invention, without diminishing the utility-passing module capacity of the tool changer 10. In another embodiment (not shown), the functionality of the tool unit pneumatic module 36 may be built into the tool unit 12, without requiring an external module 36. FIG. 3 depicts a stand-alone view of the tool unit pneumatic module 36.

The tool unit pneumatic module 36 also includes a pneumatic coupling port 30. This coupling port 30 is positioned so as to mate with the corresponding pneumatic coupling port on the master unit pneumatic module 26 when the modules 26, 36 abut. The pneumatic coupling 30 transfers pneumatic fluid supplied by or through the tool stand to the master unit pneumatic module 26 when an attached tool is disposed in the tool stand. In some embodiments, internal to the tool unit pneumatic module 36, as depicted in FIG. 3 by dashed lines, is a 3-way solenoid valve 44, referred to herein as the decouple control valve. The decouple control valve is operative to control the supply of pneumatic fluid from the tool stand to a decouple port of a pneumatically-actuated piston 56 of the coupling mechanism 16 (via the master unit pneumatic module 26) in decouple operation, as well as to vent air from the decouple chamber of the piston 56 in couple operation. The valve 44 is operated in response to a DECOUPLE command communicated from the master unit 12 to the tool unit pneumatic module 36 via an electrical connector 32 positioned to mate with the corresponding electrical connector 32 on the master unit pneumatic module 26. The tool unit pneumatic module 36 further includes a pneumatic fluid connector 46, operative to be connected to a pneumatic fluid supply on or through the tool stand.

A number of different embodiments of the present invention are disclosed and claimed herein. In all such embodiments, a couple control pneumatic valve controls pneumatic fluid flow driving the coupling actuation of the coupling mechanism 16. In most embodiments, a decouple control pneumatic valve controls pneumatic fluid flow driving the decoupling actuation. In all such embodiments, inherent safe operation of the tool changer 10 is ensured by the fact that pneumatic fluid operative to drive the decoupling actuation is sourced from, or routed through, a tool stand in which a robotic tool may be safely positioned. Only when the robotic tool is in the tool stand is decoupling pneumatic fluid available to drive the coupling mechanism 16 to the decoupled position. Once the robot removes the robotic tool from the tool stand, decoupling of the coupling mechanism 16 is not physically possible, even if control software asserts a DECOUPLE control signal (or otherwise attempts to initiate a decouple operation). The various embodiments discloses and claimed herein vary in the distribution of couple and decouple control pneumatic valves and pneumatic fluid sources, in control signal distribution, and in the relative pneumatic pressure between the different supplies. Different configurations of master and tool unit pneumatic modules 26, 36 are optimized for use in the different embodiments.

### Detailed Description of First Embodiment

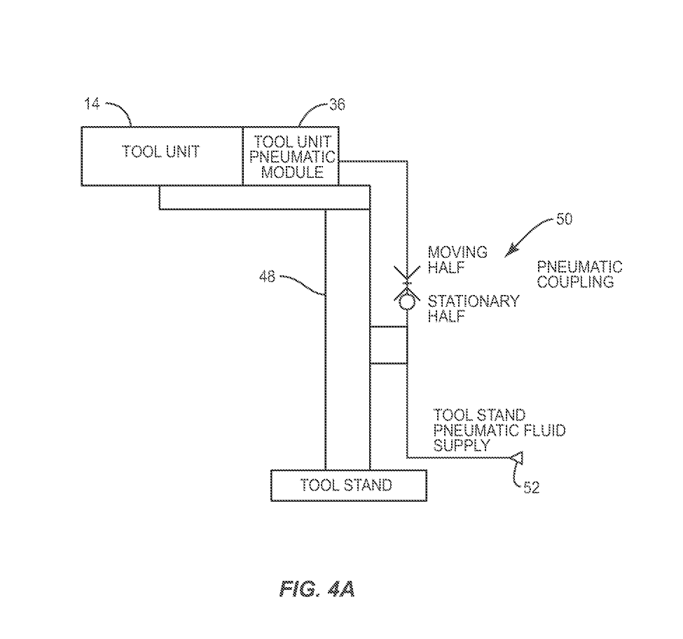

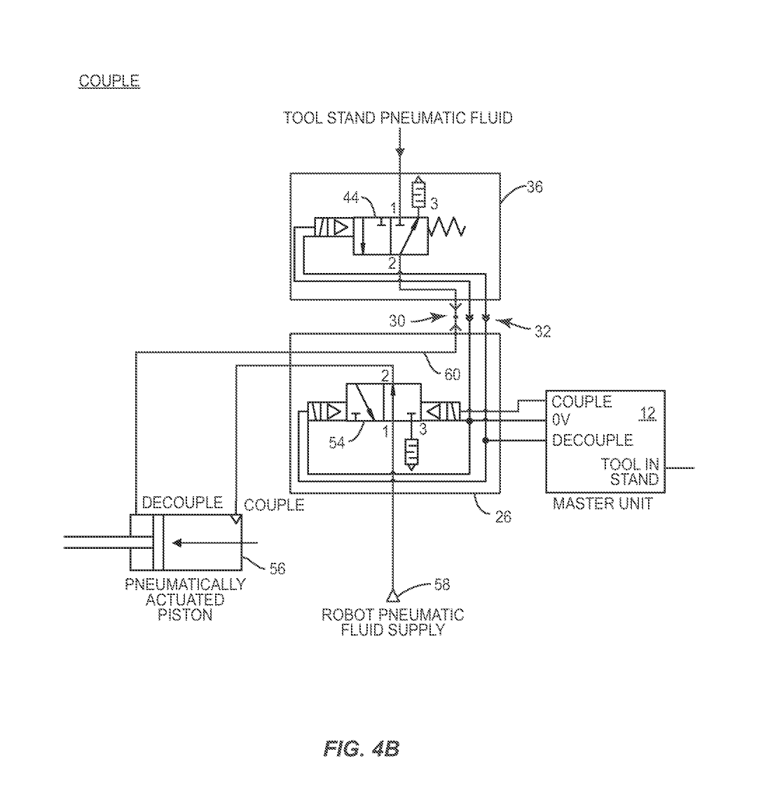

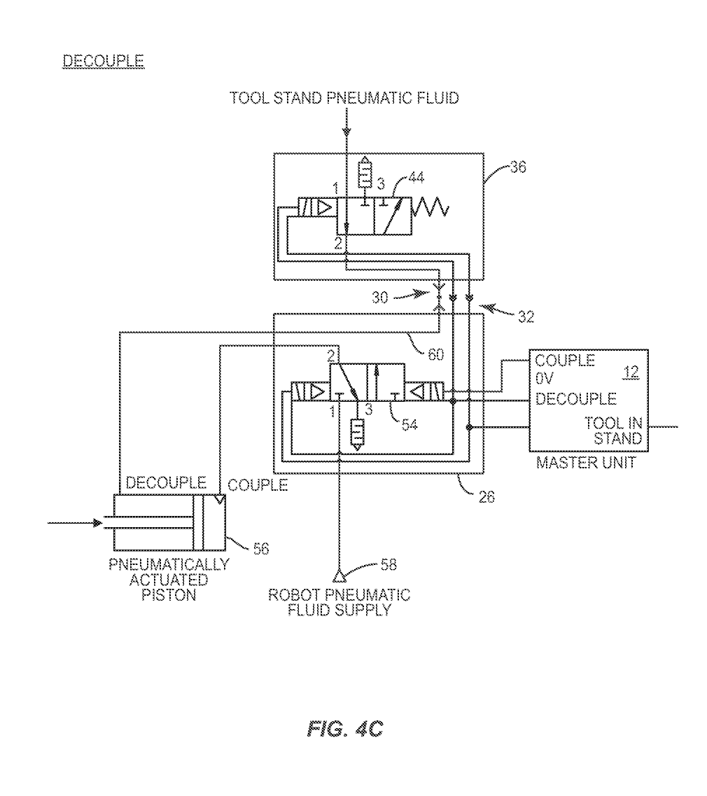

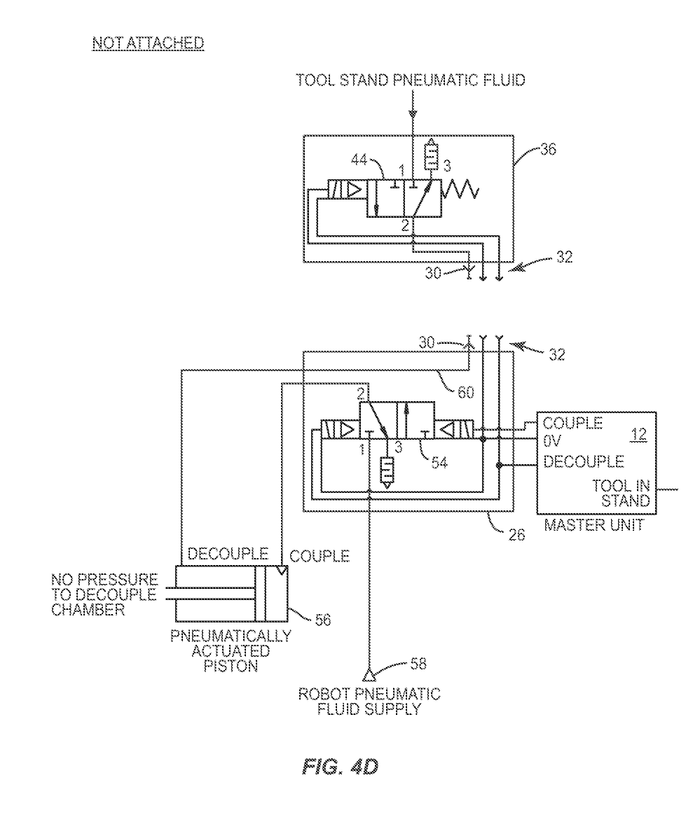

FIGS. 4A-4D depict a first embodiment, in which the couple control valve is disposed in the master unit pneumatic module, the decouple control valve is disposed in the tool unit pneumatic module, and a decoupling pneumatic fluid source is associated with the tool stand.

FIG. 4A depicts the tool unit 14 and tool unit pneumatic module 36 disposed (along with an attached robotic tool, not shown) in a tool stand 48. The tool unit pneumatic module 36 is connected, via a tool stand pneumatic coupling 50, to a tool stand pneumatic fluid supply 52. The pneumatic coupling 50 includes a check valve on the tool stand side to arrest the flow of pneumatic fluid when the robotic tool is removed from the tool stand 48. The pneumatic coupling 50 supplies pneumatic fluid from the tool stand pneumatic fluid supply 52 to the tool unit pneumatic module 36 when an attached robotic tool is safely disposed within the tool stand 48.

FIG. 4B is a schematic pneumatic diagram depicting the relevant pneumatic fluid and control signal flow when the tool changer master unit 12 couples to the tool unit 14. The master unit 12 generates COUPLE and DECOUPLE signals, which may for example comprise positive or negative voltages, with respect to a 0V reference voltage. Alternatively, the COUPLE and DECOUPLE signals may comprise digital values, optical signals, wireless signals, or any other manner of transmitting control commands known in the art. In one embodiment, the COUPLE and DECOUPLE signals comprise positive voltages, with respect to the 0V reference signal, operative to energize solenoids on the 3-way solenoid valves 26, 36 when asserted, and 0V when deasserted. The COUPLE and DECOUPLE signals are mutually exclusive—that is, the two signals are never asserted simultaneously.

Upon the COUPLE signal being asserted, the couple control valve 54 is configured to pass pneumatic fluid from a pneumatic fluid supply 58 on the robot to the couple port of the pneumatically-actuated piston 56 of the coupling mechanism 16. The decouple port of the piston 56 is connected via the above-described pneumatic flow-through conduit 60 in the master unit pneumatic module 26 to the pneumatic coupling 30. This allows air from the decouple chamber of the piston 56 to flow to the decouple control valve 44. The DECOUPLE signal, which is passed to the decouple control valve 44 via electrical connector 32, is deasserted. Because the DECOUPLE signal is deasserted, the decouple control valve 44 is in its default state, connecting the pneumatic coupling 30 to an exhaust vent. In this configuration, the piston 56 is driven forward (to the left as depicted in FIG. 4B), to couple the master unit 12 and tool unit 14 together. The piston 56 is allowed to move in the forward direction by air in the decouple chamber being vented via the decouple control valve 44.

Once the master unit 12 is coupled to the tool unit 14 and the robot removes the attached robotic tool from the tool stand 48, the units 12, 14 cannot become decoupled. The pneumatic fluid source 58 on the robot continues to supply positive pressure, through the couple control valve 54, to the couple port of the piston 56, forcing the piston 56 to the forward, or coupled, position. Critically, there is no source of pneumatic fluid connected to the decouple port of the piston 56 to drive the piston backwards, or toward the decoupled position (even if there were, air trapped in the couple chamber of the piston 56 has no path to vent, and would resist movement of the piston 56 in that direction).

FIG. 4C depicts the decouple operation. Once the robotic tool is safely disposed in the tool stand 48, and the master unit 12 receives notice of this fact, the master unit 12 and tool unit 14 may decouple. The master unit 12 deasserts the COUPLE command and asserts the DECOUPLE command, which causes the decouple control valve 44 to connect the tool stand pneumatic fluid supply 52 with the pneumatic coupling 30. The pneumatic flow-through conduit 60 in the master unit pneumatic module 26 conveys the pneumatic fluid to the decouple port of the pneumatically-actuated piston 56. Simultaneously, the DECOUPLE command causes the couple control valve 54 to direct air from the couple chamber of the piston 56 to vent. These two valve settings allow pneumatic fluid supplied by the tool stand 48 to drive the piston 56 backwards, or to a decoupled position, allowing the master unit 12 and the tool unit 14 to decouple. The robot may then move, with the master unit 12, to retrieve a different robotic tool, leaving the robotic tool safely disposed in the tool stand 48.

Note that the master unit 12 requires notice that the robotic tool is disposed in the tool stand 48. Many industrial robotic systems already generate such a “tool in stand” signal, as part of one or more safety interlocks. The “tool in stand” signal may be generated by a switch or proximity sensor on the tool stand 48, on the tool unit 14, on the robotic tool, or the like. The signal may be transmitted to the master unit 12 through mating contacts on the tool unit 14, or may alternatively be communicated to the master unit 12 from the robot.

FIG. 4D depicts the condition after decoupling, when the robot has stowed the robotic tool in the tool stand 48 and moved the master unit 12 away from the tool unit 14. The decouple control valve 44 is in the default state (no DECOUPLE signal asserted), blocking the tool stand pneumatic fluid and venting the pneumatic coupling 30. The couple control valve 54 blocks the robot pneumatic fluid and vents the air in the coupling chamber of the piston 56. Note that the couple control valve 54 is a dual-solenoid type. This avoids the master unit 12 automatically coupling in the event that power is lost, as would occur if the couple control valve 54 were a “spring return” type valve with only one solenoid. In this case, the master unit 12 would be unable to couple to a tool unit 14, without a manual reconfiguration of the piston 56. By using a dual-solenoid type valve 54, the master unit 12 will only couple upon activation of the COUPLE control signal, which only occurs when the master unit 12 is proximate a tool unit 14 and ready to couple thereto.

The first embodiment is a straightforward implementation of the inventive concept of making a robotic tool changer 10 inherently safe by providing decoupling power only when an attached robotic tool is safely disposed in a tool stand. To the greatest extent possible, this embodiment contains all of the functionality within the tool changer 10. Since the robot pneumatic fluid supply 58 is required for operation of any pneumatically-operated tool changer, the only modification required at the facility where the robot is deployed is the provision of a tool stand pneumatic fluid supply 52, and a tool stand pneumatic coupling 50. Accordingly, the first embodiment may be particularly advantageous where required modifications to a facility should be minimized.

### Detailed Description of Second Embodiment

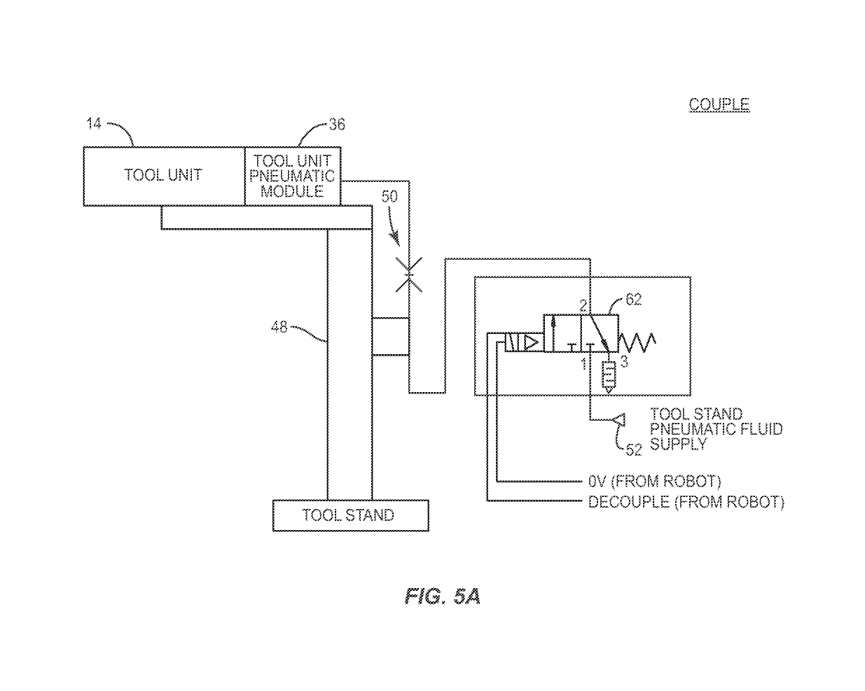

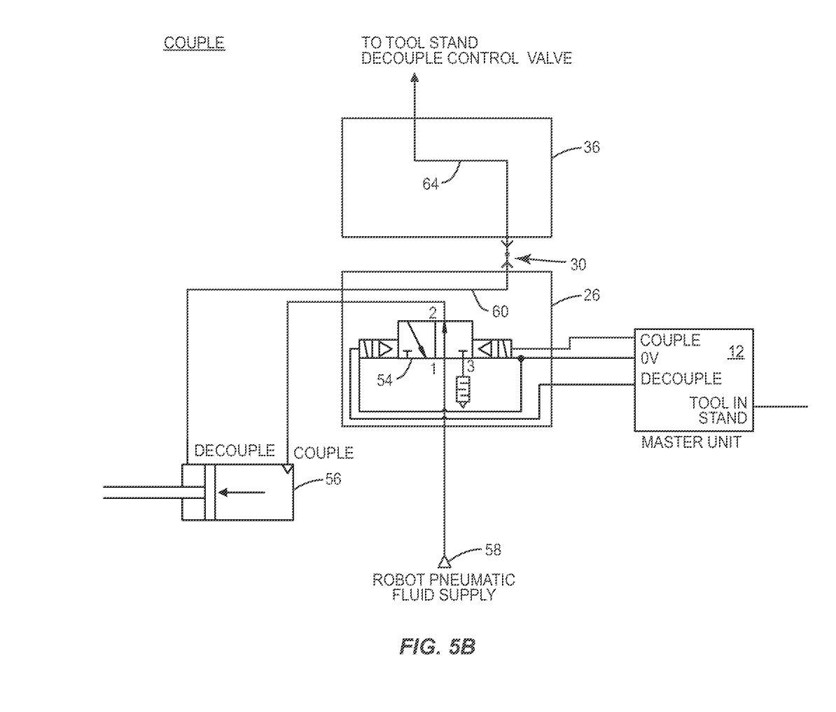

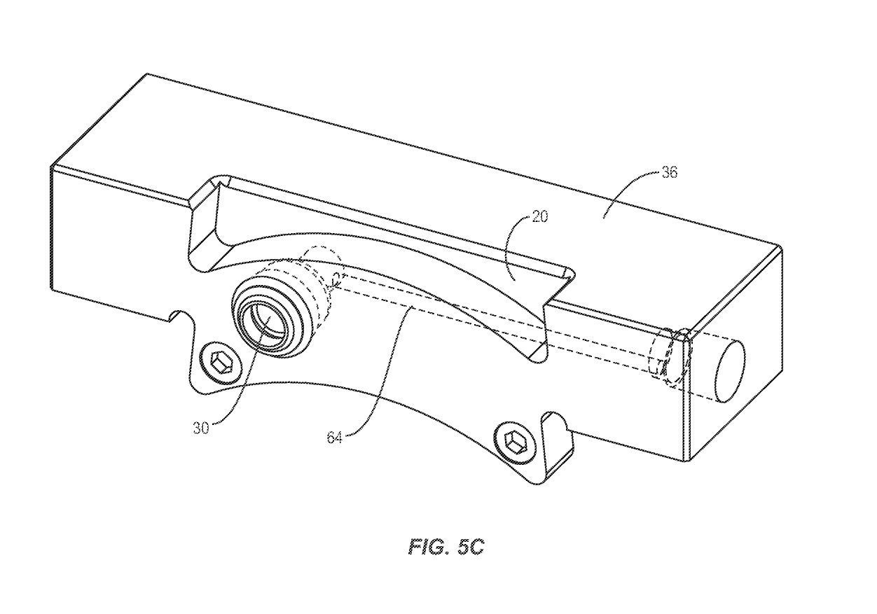

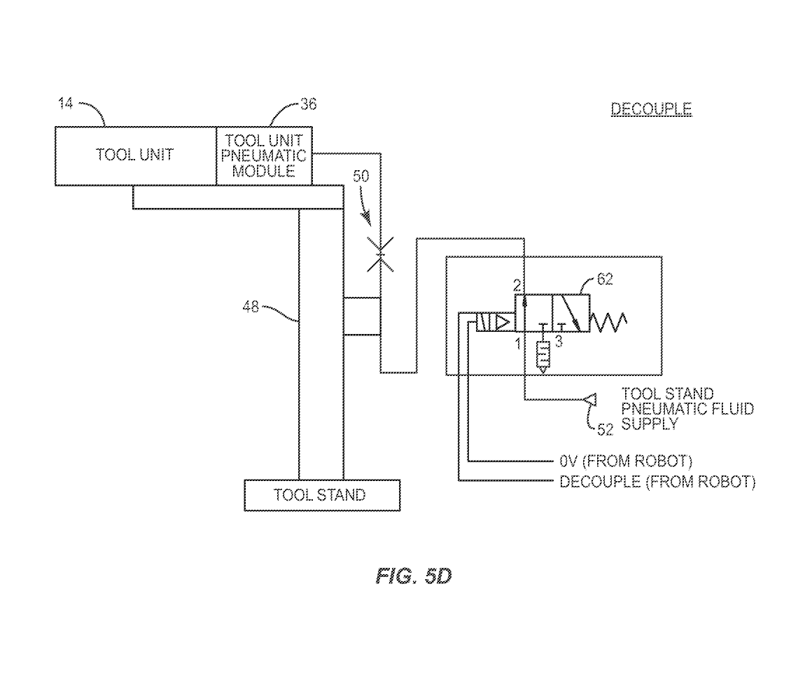

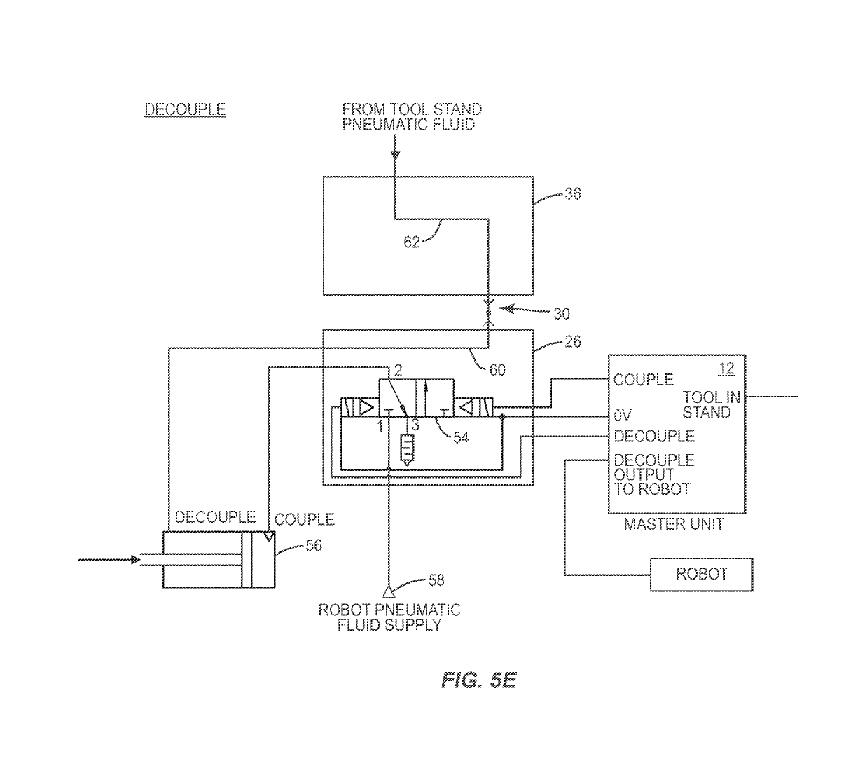

FIGS. 5A-5E depict a second embodiment, in which the couple control valve is disposed in the master unit pneumatic module, the decouple control valve is disposed on or otherwise associated with the tool stand, and a decoupling pneumatic fluid source is associated with the tool stand.

FIGS. 5A and 5B depict the coupling operation, with the tool stand pneumatic fluid supply 52 providing pneumatic fluid to a 3-way solenoid decouple control valve 62, which in this embodiment is associated with the tool stand 48. The decouple control valve 62 in this embodiment receives the DECOUPLE command from the robot. As in the first embodiment, the tool unit pneumatic module 36 connects to the tool stand pneumatic fluid via pneumatic coupling 50 when an attached robotic tool is disposed in the tool stand 48.

Referring to FIG. 5B, the master unit 12 and master unit pneumatic module 26 are the same as described above with respect to the first embodiment. In this second embodiment, the tool unit pneumatic module 36 does not include a valve or receive control signals, but rather includes a pneumatic pass-through conduit 64 connecting the pneumatic coupling 30 to the tool stand pneumatic coupling 50. FIG. 5C is a perspective view of this embodiment of the tool unit pneumatic module 36. In this embodiment, the tool unit pneumatic module 36 has the same physical dimensions as that in the first embodiment (see FIG. 3); however the pneumatic pass-through conduit 64 (depicted in dashed lines) replaces the decouple control valve 44. Additionally, this embodiment of the tool unit pneumatic module 36 does not include signal connections to the master unit pneumatic module 26.

In the second embodiment, coupling operates similarly to that described above for the first embodiment. Upon the COUPLE signal being asserted, the couple control valve 54 is configured to pass pneumatic fluid from the robot pneumatic fluid supply 58 to the couple port of the pneumatically-actuated piston 56. The decouple port of the piston 56 is connected via the pneumatic flow-through conduit 60 in the master unit pneumatic module 26 to the pneumatic coupling 30. This allows pneumatic fluid from the decouple chamber of the piston 56 to flow through the pneumatic flow-through conduit 64 in the tool unit pneumatic module 36, and the tool stand pneumatic coupling 50, to the decouple control valve 62. The DECOUPLE signal, which is passed to the decouple control valve 62 by the robot, is deasserted. Because the DECOUPLE signal is deasserted, the decouple control valve 62 is in its default state, connecting the tool stand pneumatic coupling 50 to an exhaust vent. In this configuration, the piston 56 is driven forward, to couple the master unit 12 and tool unit 14 together. The piston 56 is allowed to move in the first direction by air in the decouple chamber being vented via the decouple control valve 62.

Once the master unit 12 is coupled to the tool unit 14 and the robot removes the attached robotic tool from the tool stand 48, the units 12, 14 cannot become decoupled. The robot pneumatic fluid source 58 continues to supply positive pressure, through the couple control valve 54, to the couple port of the piston 56, forcing the piston 56 to the forward, or coupled, position. Critically, there is no source of pneumatic fluid connected to the decouple port of the piston 56 to drive the piston backward, toward the decoupled position (even if there were, air trapped in the couple chamber of the piston 56 has no path to vent, and would resist movement of the piston 56 in that direction).

FIGS. 5D and 5E depict the decouple operation. Once the robotic tool is safely disposed in the tool stand 48, and the master unit 12 receives notice of this fact, the master unit 12 and tool unit 14 may decouple. The master unit 12 deasserts the COUPLE signal and asserts the DECOUPLE signal, and distributes it to both the couple control valve 54 and to the robot. The robot relays the DECOUPLE signal (either directly, or as a digital command, via a network, or in any other manner) to the decouple control valve 62. The DECOUPLE signal provided by the robot to the decouple control valve 62 causes the decouple control valve 62 to connect the tool stand pneumatic fluid supply 52 to the pneumatic coupling 50. Pneumatic fluid then flows to the tool side pneumatic module 36.

The pneumatic fluid flows through the pneumatic flow-through conduit 62 in the tool unit pneumatic module 36, through the pneumatic coupling 30 into the master unit pneumatic module 26, and through the pneumatic flow-through conduit 60 to the decouple port of the pneumatically-actuated piston 56. Simultaneously, the DECOUPLE command causes the couple control valve 54 to direct air from the couple port of the piston 56 to vent. These two valve settings allow pneumatic fluid supplied by the tool stand 48 to drive the piston 56 backwards, or to a decoupled position, allowing the master unit 12 and the tool unit 14 to decouple. The robot may then move, with the master unit 12, to retrieve a different robotic tool, leaving the robotic tool safely disposed in the tool stand 48.

The second embodiment removes the decouple control valve from the tool changer 10 to the tool stand. A tool unit 14 (and tool unit pneumatic module 36, if separate) is typically permanently installed on every tool that a robot may utilize. In a facility where only a subset of the available robotic tools may be utilized by a given robot, and the tools can operate using the same tool stand, the second embodiment reduces cost, maintenance, and risk by minimizing the required replication of the decouple control valve. Placing the decouple control valve on the tool stand may also allow for easier inspection, maintenance, or replacement, as opposed to disassembling each tool unit pneumatic module 36. Additionally, the cost and complexity of the tool unit pneumatic module 36 is dramatically reduced, as it has no pneumatic valve or electrical connections.

### Detailed Description of Third Embodiment

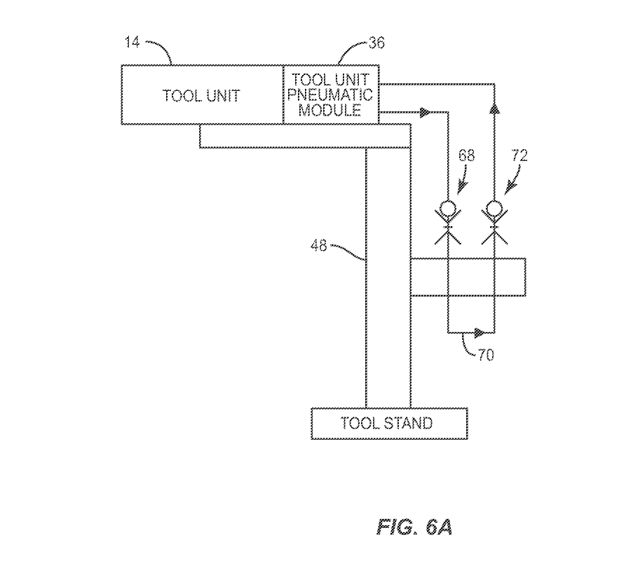

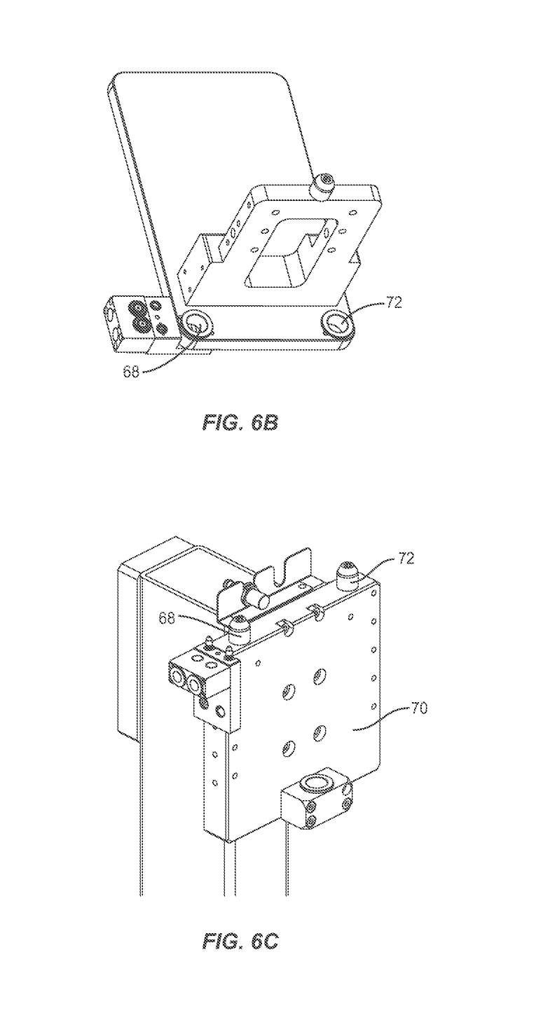

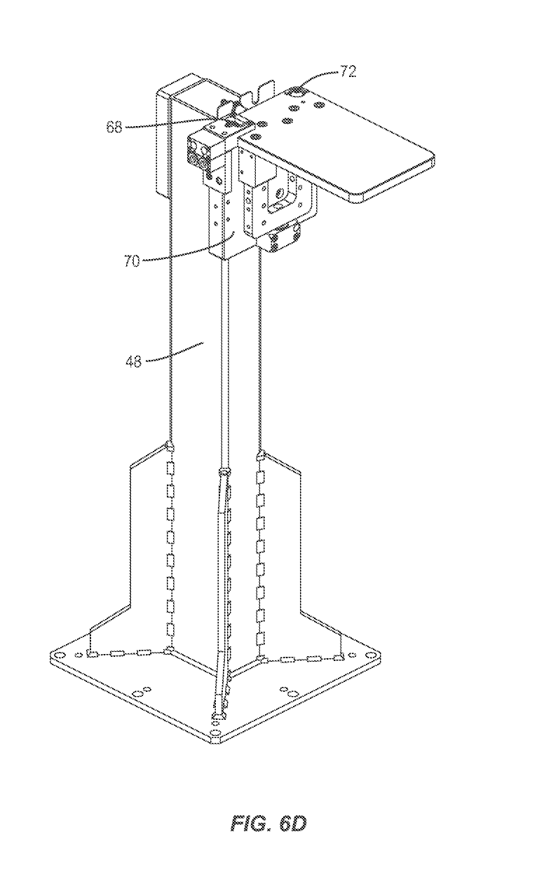

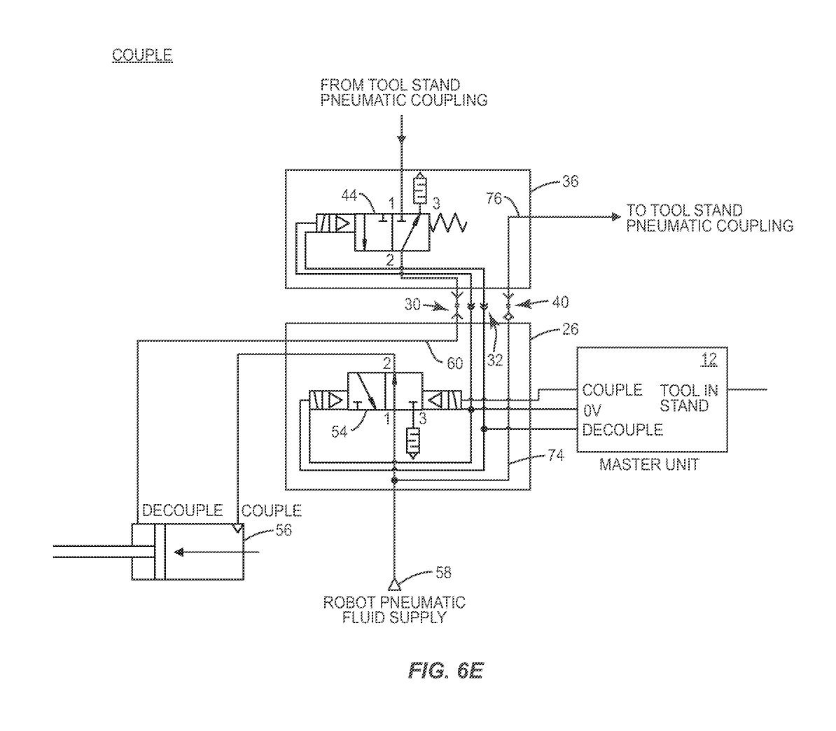

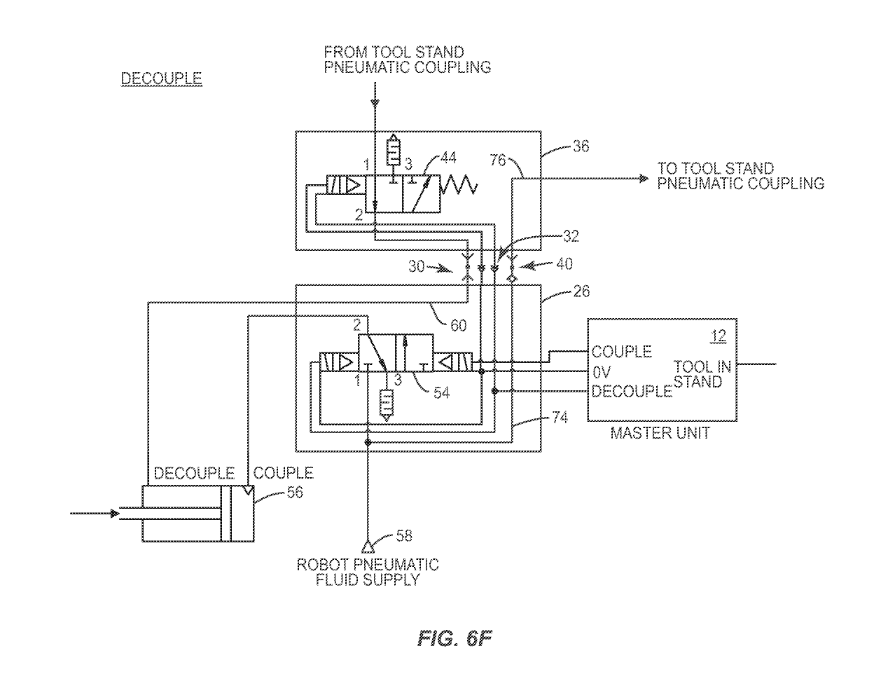

FIGS. 6A-6E depict a third embodiment, in which the couple control valve is disposed in the master unit pneumatic module, the decouple control valve is disposed in the tool unit pneumatic module, and the decoupling pneumatic fluid is routed through a bridge conduit on the tool stand prior to being directed to the coupling mechanism.

FIG. 6A depicts a pneumatic bridge conduit 70 on the tool stand 48. The bridge conduit 70 receives pneumatic fluid from the tool unit pneumatic module 36 via a supply pneumatic coupling 68, and routes the pneumatic fluid back to the tool unit pneumatic module 36 via a return pneumatic coupling 72. Both pneumatic couplings 68, 72 are engaged when the robot positions an attached robotic tool in the tool stand 48. Check valves on the tool changer side of the pneumatic couplings 68, 72 prevent the leakage of pneumatic fluid when the robotic tool is removed from the tool stand 48.

FIG. 6B depicts an attachment to the tool unit pneumatic module 36 that presents supply and return pneumatic couplings 68, 72, respectively, to the tool stand 48. FIG. 6C depicts an attachment to the tool stand 48 with mating supply and return pneumatic couplings 68, 72, respectively, connected to a pneumatic bridge conduit 70 internal to the attachment. FIG. 6D depicts the two attachments as they are configured when a robotic tool is disposed in the tool stand 48 (the tool unit 14, tool unit pneumatic module 36, and robotic tool are omitted from FIG. 6D for clarity).

FIG. 6E depicts the pneumatic and control signal flow between the master and tool unit pneumatic modules 26, 36. The master unit 12 and master unit pneumatic module 26 are similar to those described above with respect to the first embodiment, with the addition of a pneumatic pass-through conduit 74 connecting the robot pneumatic fluid supply 58 to a second pneumatic coupling port 40. The coupling port 40 is positioned and operative to mate with a corresponding pneumatic coupling port on the tool unit pneumatic module 36. In this third embodiment, the tool unit 14 and tool unit pneumatic module 36 are also similar to those described above with respect to the first embodiment, with the addition of the second pneumatic coupling port 40 and a pneumatic pass-through conduit 76 connecting the pneumatic coupling 40 to the tool stand supply pneumatic coupling 68.

In this embodiment, when an attached robotic tool is disposed in the tool stand 48, pneumatic fluid flows from the robot pneumatic fluid supply 58, through the master and tool unit pneumatic modules 26, 36, through the supply pneumatic coupling 68, bridge conduit 70, and return pneumatic coupling 72 on the tool stand 48, and back to the tool unit pneumatic module 36. From there, it is selectively routed to the decouple port of the pneumatically-actuated piston 56, as in previously described embodiments. Removal of the robotic tool from the tool stand 48 breaks this pneumatic fluid flow path, disallowing decoupling of the coupling mechanism 16.

In the third embodiment, coupling operates similarly to that described above for the first embodiment. Upon the COUPLE signal being asserted, the couple control valve 54 is configured to pass pneumatic fluid from the robot pneumatic fluid supply 58 to the couple port of the pneumatically-actuated piston 56. The decouple port of the piston 56 is connected via the pneumatic flow-through conduit 60 in the master unit pneumatic module 26 to the pneumatic coupling 30. This allows pneumatic fluid from the decouple chamber of the piston 56 to flow through the pneumatic coupling 30 to the tool unit valve 44. The DECOUPLE signal, which is passed to the tool unit valve 44 via the electrical coupling 32, is deasserted. Because the DECOUPLE signal is deasserted, the decouple control valve 44 is in its default state, connecting the pneumatic coupling 30 to an exhaust vent. In this configuration, the piston 56 is driven forward, in the first direction, to couple the master unit 12 and tool unit 14 together. The piston 56 is allowed to move in the first direction by air in the decouple chamber being vented via the decouple control valve 44.

Once the master unit 12 is coupled to the tool unit 14 and the robot removes the attached robotic tool from the tool stand 48, the units 12, 14 cannot become decoupled. The robot pneumatic fluid source 58 continues to supply positive pressure, through the couple control valve 54, to the couple port of the piston 56, forcing the piston 56 to the forward, or coupled, position. Critically, because pneumatic fluid to drive the decouple port of the piston 56 is routed through a bridge 70 on the tool stand 48, once the robotic tool is removed from the tool stand 48, there is no source of pneumatic fluid connected to the decouple port of the piston 56 to drive the piston backward, toward the decoupled position (even if there were, air trapped in the couple chamber of the piston 56 has no path to vent, and would resist movement of the piston 56 in that direction).

FIG. 6F depicts the decouple operation. Once the robotic tool is safely disposed in the tool stand 48, and the master unit 12 receives notice of this fact, the master unit 12 and tool unit 14 may decouple. The master unit 12 deasserts the COUPLE signal and asserts the DECOUPLE signal, which causes the decouple control valve 44 to pass pneumatic fluid from the return coupling 72 of the bridge 70 to the pneumatic coupling 30. The pneumatic flow-through conduit 60 in the master unit pneumatic module 26 conveys the pneumatic fluid to the decouple port of the piston 56. Simultaneously, the DECOUPLE command causes the couple control valve 54 to direct air from the couple port of the piston 56 to vent. These two valve settings allow pneumatic fluid supplied by the robot pneumatic source 58, but routed through the tool stand 48, to drive the piston 56 backwards, or to a decoupled position, allowing the master unit 12 and the tool unit 14 to decouple. The robot may then move, with the master unit 12, to retrieve a different robotic tool, leaving the robotic tool safely disposed in the tool stand 48.

The third embodiment employs only a single pneumatic fluid source for both couple and decouple operations, yet implements the inherently safe feature by routing decouple pneumatic fluid through the tool stand. Since, as noted above, many robots already provide a pneumatic fluid supply, the third embodiment may require minimal changes to a facility—only the addition of supply and return pneumatic couplings and a pneumatic bridge conduit to the tool stand. On the other hand, the cost and complexity of the master and tool unit pneumatic modules is increased, as they required additional pneumatic pass-through conduits and an additional pneumatic coupling.

### Detailed Description of Fourth Embodiment

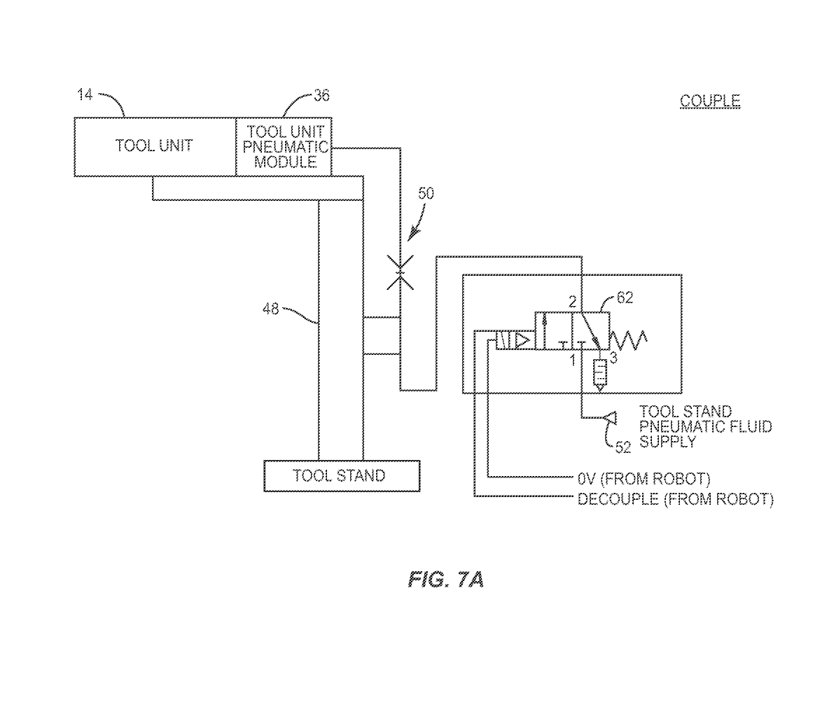

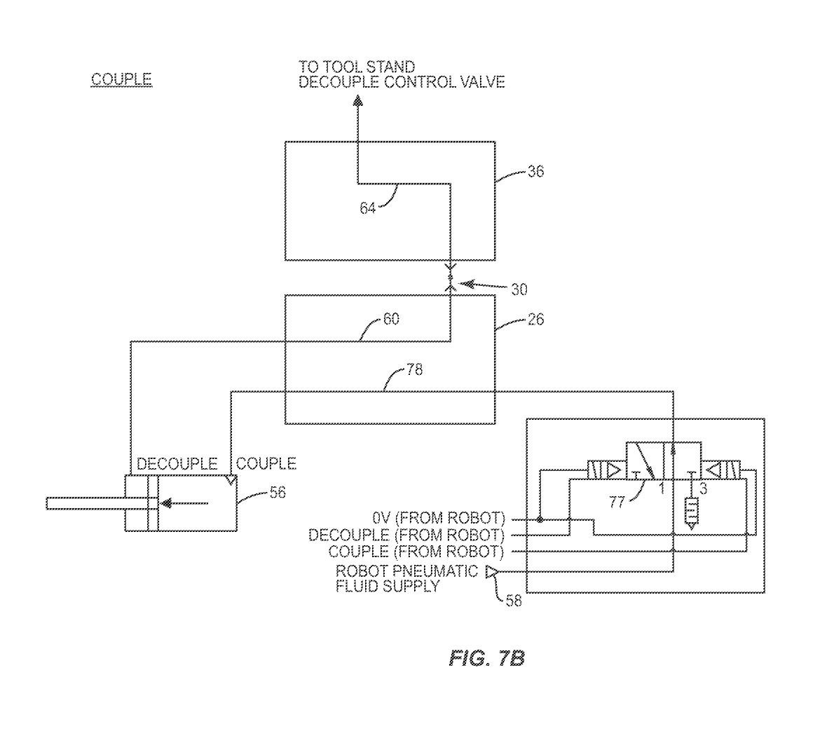

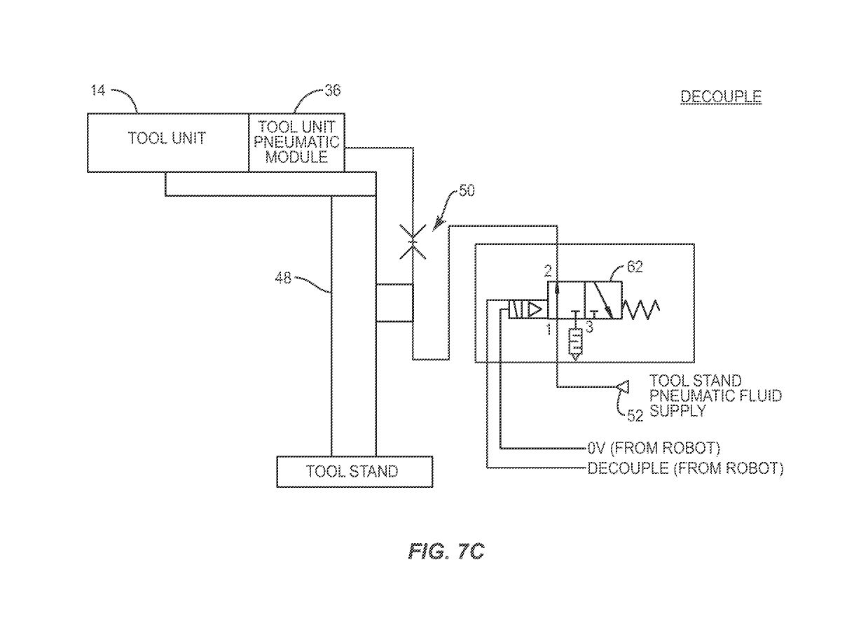

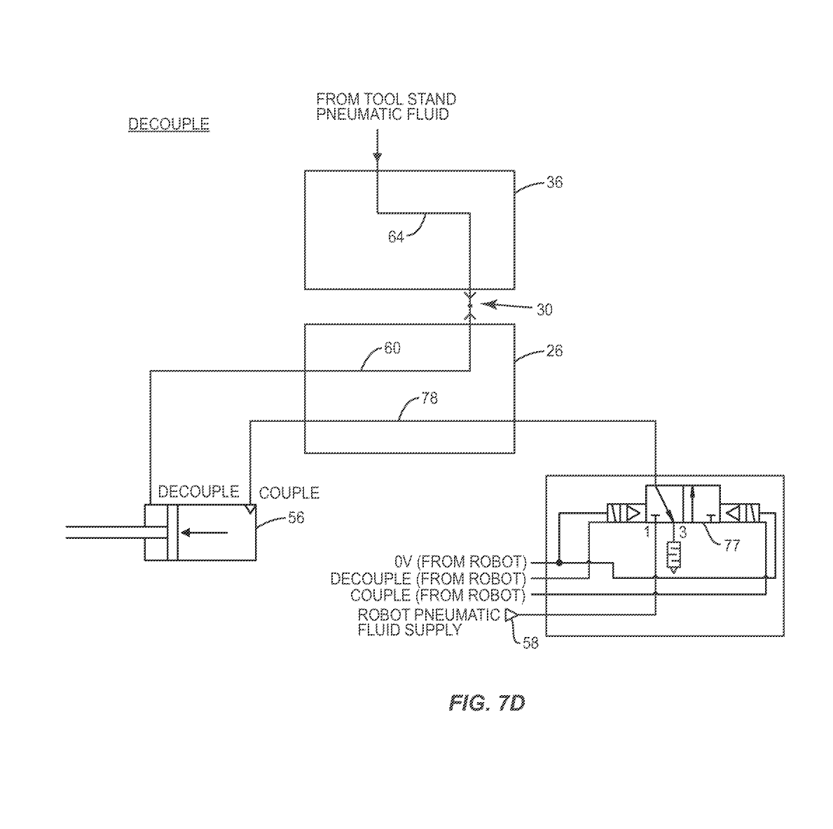

FIGS. 7A-7D depict a fourth embodiment, in which the couple control valve is associated with the robot, the decouple control valve is associate with the tool stand, a decoupling pneumatic fluid source is associated with the tool stand, and both the master and tool unit pneumatic modules include only pneumatic pass-through circuits.

FIGS. 7A and 7B depict the coupling operation. The tool stand pneumatic fluid supply 52 provides pneumatic fluid to a 3-way solenoid decouple control valve 62, which is associated with the tool stand 48, as in the second embodiment describe above. The decouple control valve 62 receives the DECOUPLE command from the robot. As in the second embodiment, the tool unit pneumatic module 36 connects to the tool stand pneumatic fluid via pneumatic coupling 50 when an attached robotic tool is disposed in the tool stand 48.

FIG. 7B depicts that a couple control valve 76 is associated with the robot. In this embodiment, the tool unit pneumatic module 36 is the same as described above with respect to the second embodiment—including a pneumatic pass-through conduit 64 but no valve or control signals. The master unit pneumatic module 26 also includes no valve or control signals, and comprises two pneumatic pass-through conduits 60 and 78. The pneumatic pass-through conduit 60 is as described above in all embodiments; the pneumatic pass-through conduit 78 connects the couple port of the pneumatically-actuated piston 56 with the couple control valve 77 associated with the robot.

In the fourth embodiment, coupling operates similarly to that described above, but with the coupling control valve 77 being associated with, and receiving commands from, the robot. Upon the COUPLE signal being asserted, the couple control valve 77 is configured to pass pneumatic fluid from the robot pneumatic fluid supply 58, through the pneumatic pass-through conduit 78 in the master unit pneumatic module 26, to the couple port of the pneumatically-actuated piston 56. The decouple port of the piston 56 is connected via the pneumatic flow-through conduit 60 in the master unit pneumatic module 26 to the pneumatic coupling 30. This allows pneumatic fluid from the decouple chamber of the piston 56 to flow through the pneumatic flow-through conduit 64 in the tool unit pneumatic module 36, and the tool stand pneumatic coupling 50, to the decouple control valve 62. The DECOUPLE signal, which is passed to the decouple control valve 62 by the robot, is deasserted. Because the DECOUPLE signal is deasserted, the decouple control valve 62 is in its default state, connecting the tool stand pneumatic coupling 50 to an exhaust vent. In this configuration, the piston 56 is driven forward, in the first direction, to couple the master unit 12 and tool unit 14 together. The piston 56 is allowed to move in the first direction by air in the decouple chamber being vented via the decouple control valve 62.

Once the master unit 12 is coupled to the tool unit 14 and the robot removes the attached robotic tool from the tool stand 48, the units 12, 14 cannot become decoupled. The robot pneumatic fluid source 58 continues to supply positive pressure, through the couple control valve 77, to the couple port of the piston 56, forcing the piston 56 to the forward, or coupled, position. Critically, there is no source of pneumatic fluid connected to the decouple port of the piston 56 to drive the piston backward, toward the decoupled position (even if there were, air trapped in the couple chamber of the piston 56 has no path to vent, and would resist movement of the piston 56 in that direction).

FIGS. 7C and 7D depict the decouple operation. Once the robotic tool is safely disposed in the tool stand 48 (the robot is aware of this fact), the master unit 12 and tool unit 14 may decouple. The robot deasserts the COUPLE signal and asserts the DECOUPLE signal, and distributes it to the couple control valve 77. The robot relays the DECOUPLE signal (either directly, as a digital command, via a network, or in any other manner) to the decouple control valve 62. The DECOUPLE signal provided by the robot to the decouple control valve 62 causes the decouple control valve 62 to connect the tool stand pneumatic fluid supply 52 with the pneumatic coupling 50. Pneumatic fluid then flows to the tool side pneumatic module 36.

The decoupling pneumatic fluid then flows through the pneumatic flow-through conduit 62 in the tool unit pneumatic module 36, through the pneumatic coupling 30 into the master unit pneumatic module 26, and through the pneumatic flow-through conduit 60 to the decouple port of the pneumatically-actuated piston 56. Simultaneously, the DECOUPLE command causes the couple control valve 77 to direct air from the couple port of the piston 56 to vent. These two valve settings allow pneumatic fluid supplied by the tool stand 48 to drive the piston 56 backwards, or to a decoupled position, allowing the master unit 12 and the tool unit 14 to decouple. The robot may then move, with the master unit 12, to retrieve a different robotic tool, leaving the robotic tool safely disposed in the tool stand 48.

The fourth embodiment removes both couple and decouple control valves from the tool changer 10 to the facility equipment (i.e., robot and tool stand). This embodiment minimizes the cost and complexity of the master and tool unit pneumatic modules, as neither includes any valve or electrical contacts. Accordingly, the fourth embodiment may be preferred where the cost of the tool changer 10 is to be minimized.

### Detailed Description of Fifth Embodiment

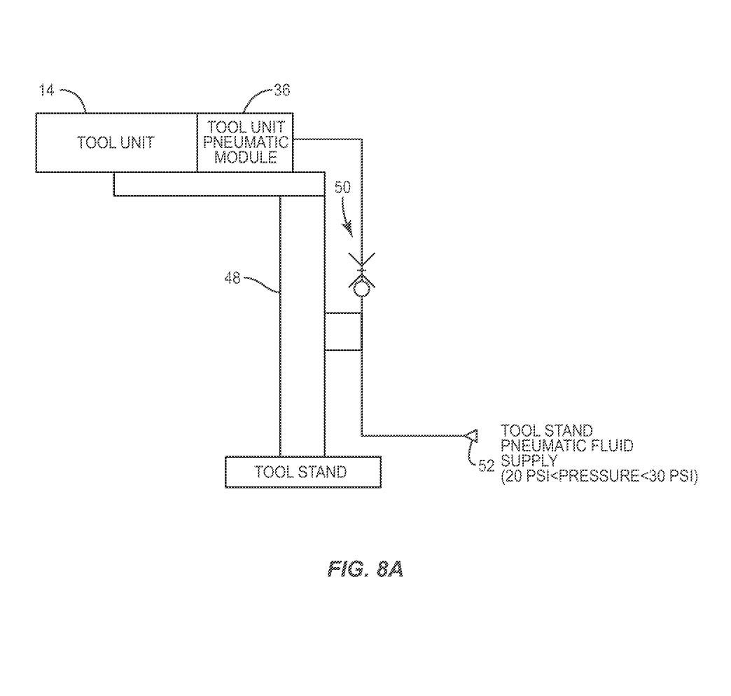

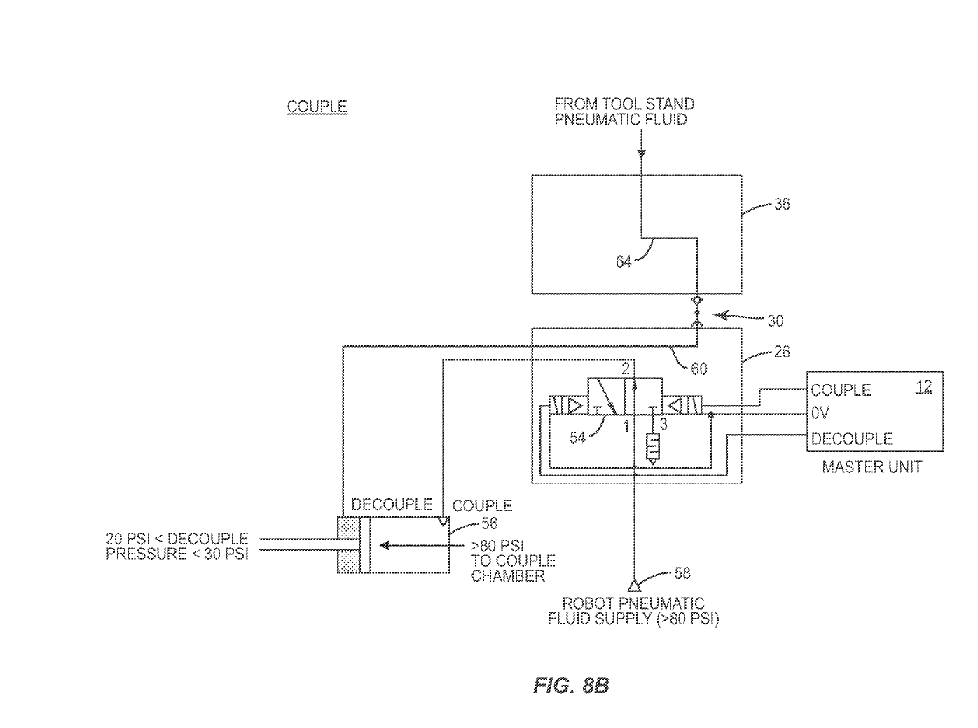

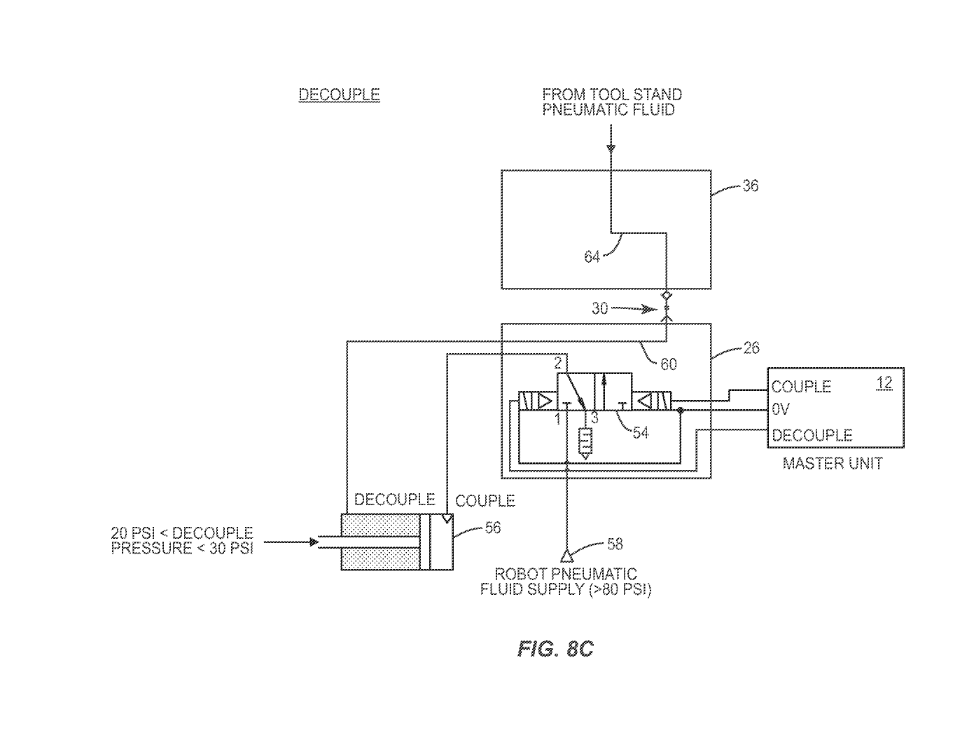

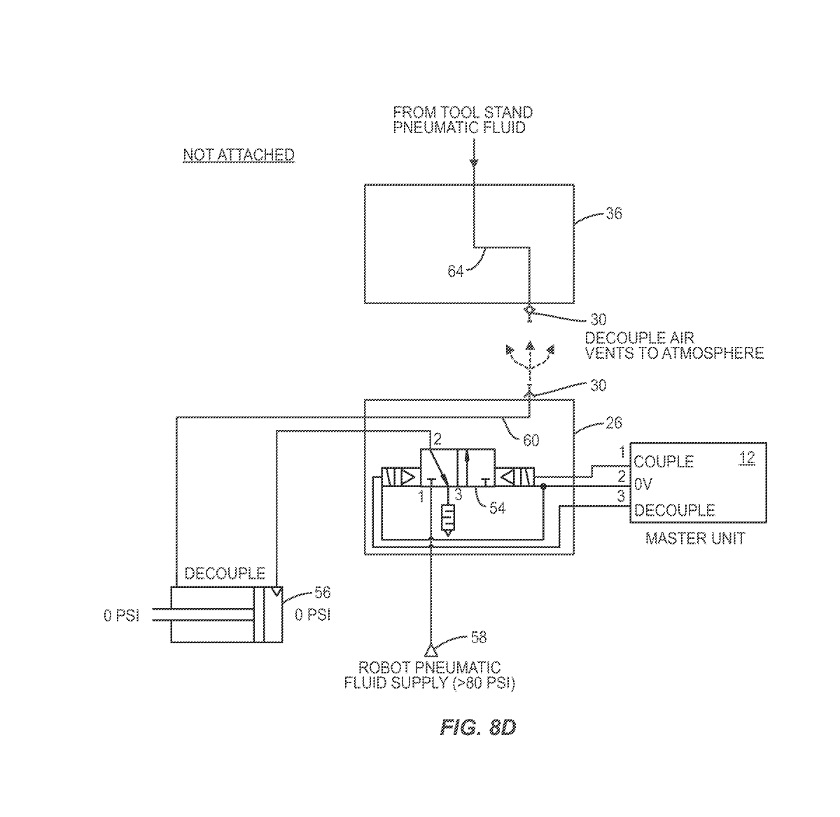

FIGS. 8A-8D depict a fifth embodiment, in which the couple control valve is disposed in the master unit pneumatic module, a decoupling pneumatic fluid supply is associated with the tool stand, and there is no decouple control valve.

FIG. 8A depicts the tool unit 14 and tool unit pneumatic module 36 disposed (along with an attached robotic tool, not shown) in the tool stand 48. As in the first embodiment, the tool unit pneumatic module 36 is connected, via a pneumatic coupling 50, to a tool stand pneumatic fluid supply 52. The tool stand pneumatic fluid supply 52 supplies pneumatic fluid at a first pressure, such as between 20 and 30 psi. The pneumatic coupling 50, which includes a check valve on the tool stand side to arrest the flow of pneumatic fluid when the robotic tool is removed from the tool stand 48, supplies pneumatic fluid at the first pressure from the tool stand pneumatic fluid supply 52 to the tool unit pneumatic module 36 when an attached robotic tool is safely disposed within the tool stand 48.

FIG. 8B depicts the pneumatic and control signal flow between the master and tool unit pneumatic modules 26, 36 during a coupling operation. The master unit 12 and master unit pneumatic module 26 are the same as described above with respect to the first and second embodiments. That is, the master unit pneumatic module 26 includes the couple control valve 54 receiving pneumatic fluid from the robot pneumatic fluid supply 58 at a second pressure, greater than the first pressure of the tool stand pneumatic fluid supply 52. For example, the robot pneumatic fluid supply 58 may supply pneumatic fluid at a pressure greater than 80 psi. The master unit pneumatic module 26 also includes a pneumatic pass-through conduit 60 connecting the decouple port of the piston 56 to the pneumatic coupling 30. The tool unit 14 and tool unit pneumatic module 36 are the similar to those described above with respect to the second and fourth embodiments. That is, the tool unit pneumatic module 36 includes only a pneumatic pass-through conduit 64, and does not receive any electrical signals. However, in this embodiment, the pneumatic coupling port 30 is a checked port operative to arrest the flow of pneumatic fluid when the master unit pneumatic module 26 and tool unit pneumatic module 36 are separated.

Unlike all previously described embodiments, in the fifth embodiment, the tool changer 10 does not employ a decouple control valve (whether disposed in the tool unit pneumatic module 36 or on the tool stand 48) to selectively direct decoupling pneumatic fluid to the decouple port of the piston 56, or alternatively vent the decouple chamber of the piston 56. Rather, the design relies on a substantial pressure differential between the coupling pneumatic fluid at the higher second pressure (e.g., >80 psi) and the decoupling pneumatic fluid at the lower first pressure (e.g., 20-30 psi).

The coupling operation proceeds substantially similar to those describe previously, with the exception of venting the decouple chamber of the piston 56. Upon the COUPLE signal being asserted, the couple control valve 54 is configured to pass pneumatic fluid from the robot pneumatic fluid supply 58 at the higher second pressure to the couple port of the pneumatically-actuated piston 56. The decouple port of the piston 56 is maintained at the lower first pressure by connection to the tool stand pneumatic fluid supply 52 via the pneumatic pass-through conduits 60, 64 and the tool stand pneumatic coupling 50. Because of the pressure differential, the piston 56 will actuate towards the forward, or first direction, by compressing the pneumatic fluid in the decouple chamber and the pneumatic pass-through conduits 60, 64. The piston 56 will actuate sufficiently far to safely couple the master unit 12 to the tool unit 14. However, only upon the robot removing the robotic tool from the tool stand 48 will the full locking force of the coupling mechanism 16 be achieved, as the decouple chamber of the piston 56 vents to the atmosphere through the tool changer side of the tool stand pneumatic coupling 50.

Once the master unit 12 is coupled to the tool unit 14 and the robot removes the attached robotic tool from the tool stand 48, the units 12, 14 cannot become decoupled. The robot pneumatic fluid source 58 continues to supply the higher second pressure, through the couple control valve 54, to the couple port of the piston 56, forcing the piston 56 to the forward, or coupled, position. Critically, there is no source of pneumatic fluid connected to the decouple port of the piston 56 to drive the piston backward, toward the decoupled position (even if there were, air trapped in the couple chamber of the piston 56 has no path to vent, and would resist movement of the piston 56 in that direction).

FIG. 8C depicts the decouple operation for the fifth embodiment. Once the robotic tool is safely disposed in the tool stand 48, the master unit 12 and tool unit 14 may decouple. The master unit 12 deasserts the COUPLE signal and asserts the DECOUPLE signal. This causes the couple control valve 54 to vent pressure from the couple chamber of the piston 56. The tool stand pneumatic fluid supply 52, providing pneumatic fluid at the lower first pressure, is connected via the tool stand pneumatic coupling 50, pneumatic pass-through conduit 64, coupling 30, and pneumatic pass-through circuit 60, to the decouple port of the piston 56. While the lower first pressure of the tool stand pneumatic fluid supply 52 is insufficient to overcome the higher second pressure of the robot pneumatic fluid supply 58, the DECOUPLE signal at the couple control valve 54 configures the valve 54 to present atmospheric pressure to the couple chamber of the piston 56, allowing the lower first pressure to fully decouple the coupling mechanism 16.

FIG. 8D depicts the condition after decoupling, when the robot has stowed the robotic tool in the tool stand 48 and moved the master unit 12 away from the tool unit 14. The piston 56 remains in the decoupled position, with no pressure applied to either the couple or decouple port. The couple control valve 54 vents pressure from the couple chamber of the piston 56, and pressure from the decouple chamber of the piston 56 is vented to the atmosphere via the pass-through circuit 60. With the piston 56 in the decouple position, the master unit 12 is ready to couple to the same or a different tool unit 14.

An important parameter for the fifth embodiment is the pressure differential between coupling pneumatic fluid and decoupling pneumatic fluid. The specific values describe above—that is, pneumatic fluid at the tool stand pneumatic fluid supply 52 at a first pressure in the range of 20-30 psi, and pneumatic fluid at the robot pneumatic fluid supply 58 at a second pressure greater than 80 psi—are representative only. These pneumatic pressures provide satisfactory results in tool changers 10 which have been tested. However, these pressure values are not limiting. Those of skill in the art will readily recognize that the optimal pressure differential (and absolute couple and decuple pneumatic fluid pressure values) will vary according to the design of the pneumatically-actuated piston 56, and other system components. Functional requirements for selecting the proper pressure differential in any particular implementation are that, first, enough force is generated by the piston 56 for the master unit 12 to lock onto a tool unit 14 connected to the heaviest robotic tool the robot will encounter in a particular environment or production run. Second, the decouple pneumatic fluid pressure must be sufficient to guarantee that the piston 56 will move to the decoupled position within an acceptable amount of time. Given the teachings of the present disclosure and these functional requirements, those of skill in the robotic arts may readily ascertain acceptable couple and decouple pneumatic fluid pressures for optimal operation in any given implementation.

The fifth embodiment obviates the need for a decouple control valve, thus reducing cost, parts count, complexity, and potential points of failure. Also, in the fifth embodiment the tool unit pneumatic module is of minimal cost and complexity, with no valve or electrical connections, and only one pneumatic pass-through conduit.

### Detailed Description of Sixth Embodiment

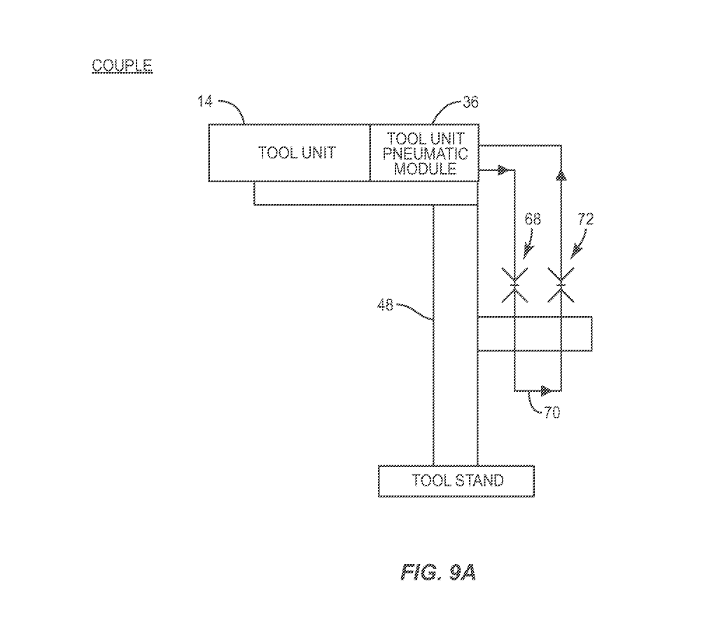

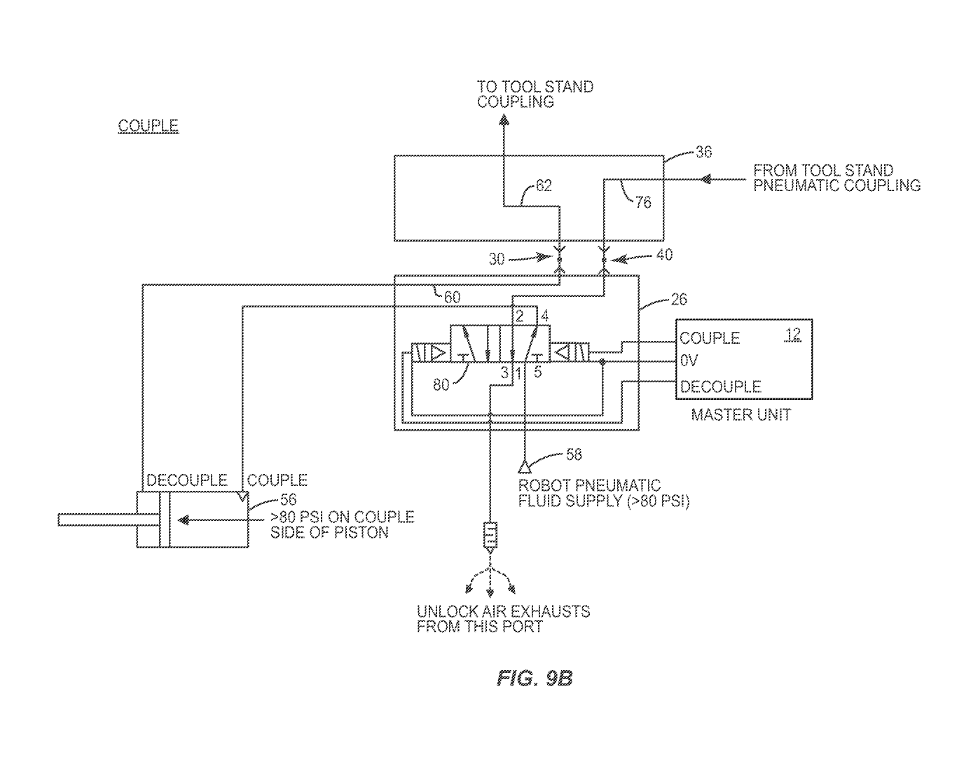

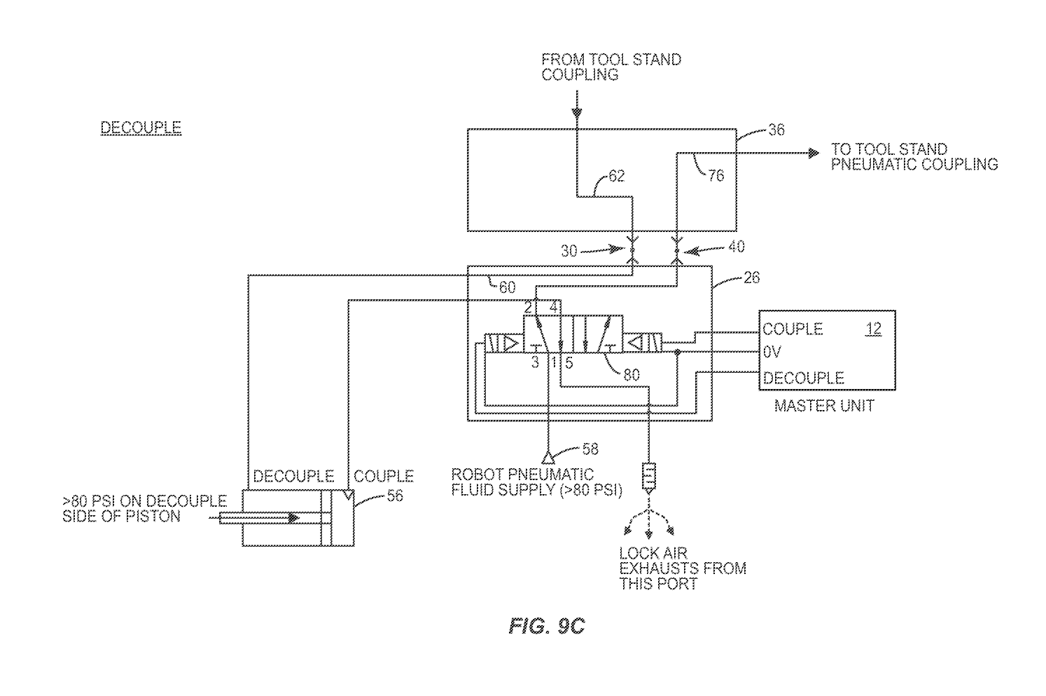

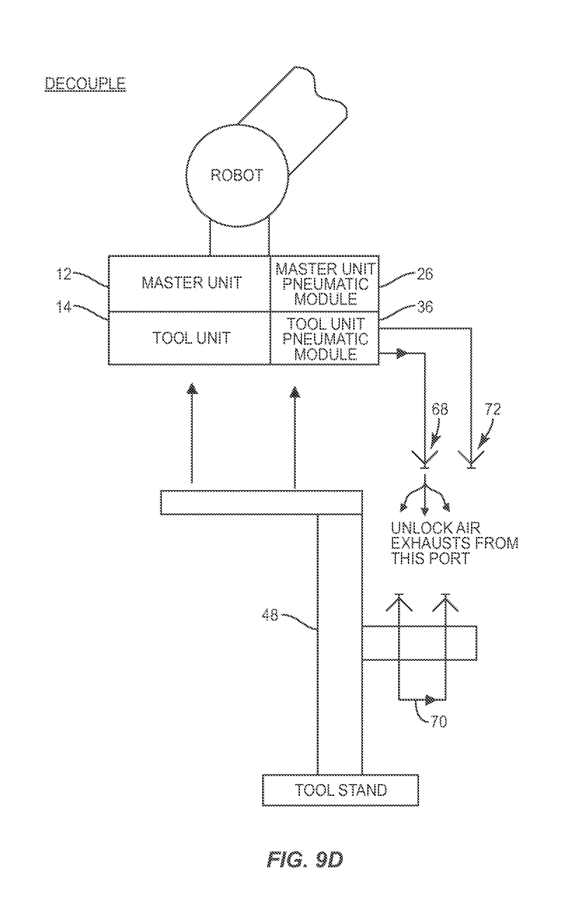

FIGS. 9A-9D depict a sixth embodiment, in which a single control valve, which is a 4-way dual solenoid valve, controls the flow of couple and decouple pneumatic fluid; the tool unit pneumatic module comprises only pneumatic pass-through conduits; and decouple pneumatic fluid is routed through a bridge conduit in the tool stand.

FIG. 9A depicts the tool unit 14 and tool unit pneumatic module 36 disposed (along with an attached robotic tool, not shown) in the tool stand 48. As in the third embodiment, the tool stand 48 includes a supply pneumatic coupling 68, pneumatic bridge conduit 70, and return pneumatic coupling 72. However, unlike the third embodiment, the supply and return pneumatic couplings 68, 72 do not include any check valves.

FIG. 9B depicts the pneumatic and control signal flow between the master and tool unit pneumatic modules 26, 36 during a coupling operation. The master unit pneumatic module 26 includes a 4-way, dual solenoid control valve 80 receiving pneumatic fluid (at a high pressure, such as >80 psi) from the robot pneumatic fluid supply 58. To couple, the control valve 80 routes pneumatic fluid from the robot supply 58 to the couple port of the pneumatically-actuated piston 56. Air in the decouple chamber of the piston 56 is vented to the atmosphere. The path for venting decouple chamber air is: from the decouple port of the piston 56 through the pneumatic pass-through conduits 60, 62, through the pneumatic bridge conduit 70 on the tool stand 48, through pneumatic pass-through conduit 76, and through the control valve 80 to the vent port. The combination of supplying high pressure pneumatic fluid to the couple port of the piston 56, and venting the decouple chamber of the piston 56 to the atmosphere, is effective to drive the piston 56 forward and couple the master unit 12 to the tool unit 14.

FIG. 9B depicts the decouple operation. Once the robotic tool is safely disposed in the tool stand 48, the master unit 12 and tool unit 14 may decouple. The master unit 12 deasserts the COUPLE signal and asserts the DECOUPLE signal, providing both to the control valve 80. This configures the control valve 80 to direct pneumatic fluid from the robot pneumatic fluid supply 58 to the pneumatic coupling 40. Decouple pneumatic fluid then flows through the pneumatic pass-through conduit 76 to the tool stand 48. The decouple pneumatic fluid then flows through the tool stand supply pneumatic coupling 68, bridge conduit 70, and return coupling 72, and back to the tool unit pneumatic module 36. The decouple pneumatic fluid then flows through the pneumatic fluid pass-through conduit 62, pneumatic coupling 30, and through the pneumatic fluid pass-through conduit 60 to the decouple port of the piston 56. As this pneumatic fluid is sourced by the robot pneumatic fluid supply 58, it is at the same high pressure (e.g., >80 psi) as the pneumatic fluid used in the couple operation. Simultaneously, the DECOUPLE command configures the control valve 80 to vent air from the couple chamber of the piston 56 to the atmosphere. The combination of supplying high pressure pneumatic fluid to the decouple port of the piston 56 via the tool stand 48, and venting the couple chamber of the piston 56 to the atmosphere, is effective to drive the piston 56 backwards and decouple the master unit 12 from the tool unit 14. The robot may then move, with the master unit 12, to retrieve a different robotic tool, leaving the robotic tool safely disposed in the tool stand 48.

Once the master unit 12 is coupled to the tool unit 14 and the robot removes the attached robotic tool from the tool stand 48, the units 12, 14 cannot become decoupled. The robot pneumatic fluid source 58 continues to supply high pressure pneumatic fluid, through the control valve 80, to the couple port of the piston 56, forcing the piston 56 to the forward, or coupled, position. Critically, there is no source of pneumatic fluid connected to the decouple port of the piston 56 to drive the piston toward the back, or decoupled, position.

Even in the event that the master unit 12 were to erroneously assert the DECOUPLE signal, decouple pneumatic fluid would be vented to the atmosphere by the tool unit pneumatic module 36, and would not be routed back to the decouple port of the piston 56. FIG. 9D depicts this condition. The DECOUPLE signal places the control valve 80 in the condition depicted in FIG. 9C, with the robot pneumatic fluid supply 58 providing decouple pneumatic fluid through the coupling 30 and pneumatic fluid pass-through conduit 76. Since the attached robotic tool is not in the tool stand 80, this pneumatic fluid is vented to the atmosphere, at the tool changer side of the supply pneumatic fluid coupling 68. As there is nothing but atmospheric pressure present at the return pneumatic fluid coupling 68, this is the pressure conveyed through the pneumatic pass-through conduits 62 and 60, and delivered to the decouple port of the piston 56. Note that the couple port of the piston 56 is also vented to atmospheric pressure, through the control valve 80. Accordingly, the piston 56 is not actively driven to the couple or decouple positions. In this case, a fail-safe mechanism, such as one or more of the mechanisms disclosed in U.S. Pat. Nos. 7,252,453 or 8,005,570, operates to prevent the master unit 12 and tool unit 14 from decoupling.

The sixth embodiment obviates the need for a decouple control valve, thus reducing cost, parts count, complexity, and potential points of failure. Full pressure is provided for both couple and decouple operations, so there will be no difference in the speed of these complimentary operations. Also, in the sixth embodiment the tool unit pneumatic module is of low cost and complexity, with no valve or electrical connections, and only two pneumatic pass-through conduits.

### Method of Inherently Safe Robotic Tool Attachment

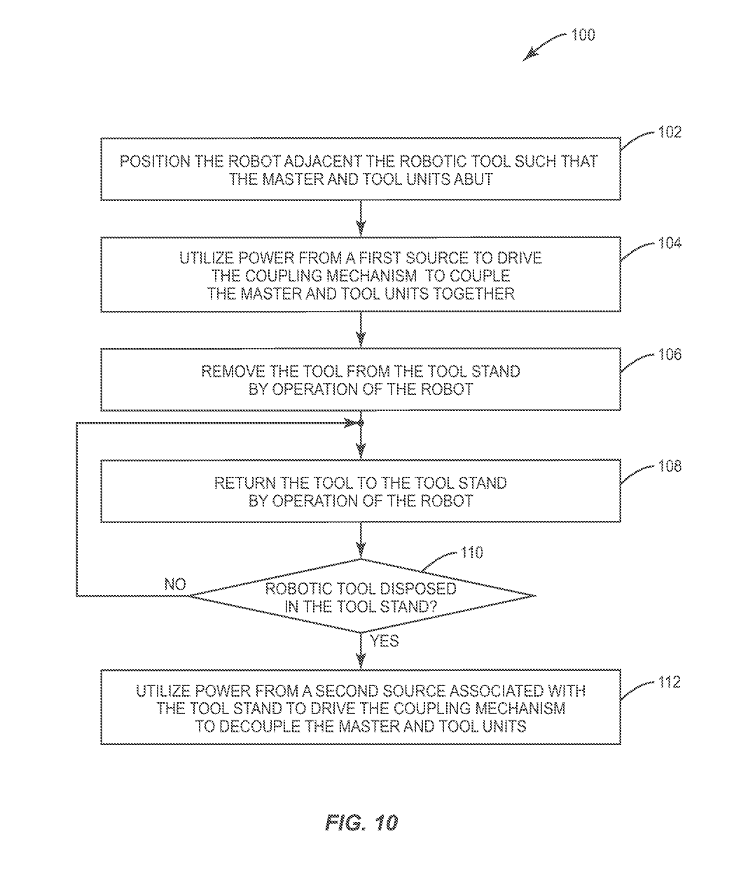

FIG. 10 depicts an inherently safe method 100 of attaching a robotic tool disposed in a tool stand 48 to a robot. A master unit 12 of a tool changer 10 is attached to the robot and a tool unit 14 of the tool changer 10 attached to the robotic tool. One of the master and tool units 12, 14 includes a coupling mechanism 16 operative to selectively couple and decouple the master and tool units 12, 14 to and from each other. The robot is positioned adjacent the robotic tool such that the master and tool units 12, 14 mechanically mate (block 102). Power from a first source 58 is used to drive the coupling mechanism 16 to couple the master and tool units 12, 14 together (block 104). The robotic tool is removed from the tool stand 48 by operation of the robot (block 106). After performing some task with the robotic tool, it is returned to the tool stand 48 by operation of the robot (block 108). If the robotic tool is safely disposed in the tool stand 48 (block 110), then power from a second source associated with the tool stand 48 is utilized to drive the coupling mechanism 16 to decouple the master and tool units 12, 14 (block 112). If the robotic tool is not safely disposed in the tool stand 48 (block 110), no power from the second source is available, and the master and tool units 12, 14 cannot be decoupled. In this case, the robotic tool must be returned to the tool stand 48 (block 108) before the tool changer 10 can decouple.

As used herein, the term “pneumatic fluid” means pressurized gas, such as for example compressed air, operative to transfer energy in pneumatic systems. In particular, pneumatic fluid is gas at a pressure higher than ambient atmospheric pressure.

Although described as being disposed in master and tool unit pneumatic modules 26, 36 attached to the master and tool units 12, 14, respectively, in other embodiments the couple and decouple control valves, pneumatic conduits, and control signals may be disposed in the master and tool units 12, 14 themselves. Accordingly, as used herein, the term “master unit assembly” refers to, for each embodiment, either the assembly of a master unit 12 and master unit pneumatic module 26, or a master unit 12 alone that includes the pneumatic valves and pneumatic conduits of the master unit pneumatic module 26. Similarly, the term “tool unit assembly” refers to, for each embodiment, either the assembly of a tool unit 14 and tool unit pneumatic module 36, or a tool unit 12 alone that includes the pneumatic valves and pneumatic conduits of the tool unit pneumatic module 36.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A robotic tool changer, comprising:
a master unit assembly operative to connect to a robot;
a tool unit assembly operative to connect to a robotic tool;
a coupling mechanism disposed in one of the master and tool unit assemblies operative to selectively couple the master and tool unit assemblies together;
wherein the coupling mechanism requires a first source of power to couple and a separate, second source of power decouple, and wherein the robotic tool changer receives the second power from a tool stand only when an attached robotic tool is disposed in the tool stand.

2. The tool changer of claim 1, wherein the coupling mechanism is pneumatically actuated, and wherein the tool changer receives pneumatic fluid from the tool stand to drive the coupling mechanism to the decoupled state.

3. The tool changer of claim 2, wherein the coupling mechanism comprises a pneumatically-actuated piston operative to couple the tool changer when pneumatic fluid is applied to a couple chamber of the piston via a couple port, and operative to decouple the tool changer when pneumatic fluid is applied to a decouple chamber of the piston via a decouple port.

4. The tool changer of claim 3 wherein the coupling mechanism is disposed in the master unit assembly;
each of the master and tool unit assemblies comprises a first pneumatic coupling positioned to mate in pneumatic fluid flow relationship when the master and tool unit assemblies are coupled together, and operative to transfer pneumatic fluid between the tool unit assembly and the master unit assembly; and
the master unit assembly includes a pneumatic fluid conduit operative to conduct pneumatic fluid between the tool unit assembly and the decouple port of the piston via the first pneumatic coupling.

5. The tool changer of claim 4 wherein the tool unit assembly comprises a first pneumatic pass-through conduit operative to conduct pneumatic fluid between the tool stand and the master unit assembly when the robotic tool is positioned in the tool stand.

6. The tool changer of claim 5 wherein the tool unit assembly is operative to receive pneumatic fluid at a first pressure from a pneumatic fluid supply on the tool stand and to transfer pneumatic fluid at the first pressure to the master unit assembly via the first pneumatic pass-through conduit and first pneumatic coupling only when the robotic tool is positioned in the tool stand;
the master unit assembly is operative to receive pneumatic fluid at a second pressure greater than the first pressure from a pneumatic fluid supply on the robot; and
the master unit assembly further comprises a couple control valve operative to direct pneumatic fluid at the second pressure to the couple port of the piston to couple and operative to vent pneumatic fluid from the couple port of the piston to decouple;
whereby the piston can only decouple if the robotic tool is positioned in the tool stand such that pneumatic fluid at the first pressure is provided at the decouple port of the piston; and
whereby pneumatic fluid at the first pressure is insufficient to decouple the piston unless pneumatic fluid at the second pressure is vented from the couple port of the piston.

7. The tool changer of claim 6 wherein the couple control valve is a 3-way solenoid valve.

8. The tool changer of claim 7 wherein the couple control valve is a 3-way, dual solenoid valve operative to not automatically configure to couple in the absence of power.

9. The tool changer of claim 5 wherein
the tool unit assembly is operative to receive pneumatic fluid from a decouple control valve associated with the tool stand and to transfer pneumatic fluid to the master unit assembly via the first pneumatic pass-through conduit and first pneumatic coupling only when the robotic tool is positioned in the tool stand;
whereby the piston can only decouple if the robotic tool is positioned in the tool stand such that pneumatic fluid from the decouple control valve associated with the tool stand is provided at the decouple port of the piston.

10. The tool changer of claim 9 wherein
the master unit assembly is operative to receive pneumatic fluid from a pneumatic fluid source on the robot; and
the master unit assembly further comprises a couple control valve operative to direct pneumatic fluid to the couple port of the piston to couple and operative to vent pneumatic fluid from the couple port of the piston to decouple.

11. The tool changer of claim 10 wherein the couple control valve is a 3-way solenoid valve.

12. The tool changer of claim 11 wherein the couple control valve is a 3-way, dual solenoid valve operative to not automatically configure to couple in the absence of power.

13. The tool changer of claim 9 wherein
the master unit assembly is operative to receive pneumatic fluid from a couple control valve associated with the robot and to transfer pneumatic fluid through a master unit assembly pneumatic pass-through conduit to the couple port of the piston to couple; and
the master unit assembly is further operative to vent pneumatic fluid from the couple port of the piston through the master unit assembly pneumatic pass-through conduit to the couple control valve associated with the robot to decouple.

14. The tool changer of claim 5 wherein
each of the master and tool unit assemblies further comprises a second pneumatic coupling positioned to mate in pneumatic fluid flow relationship when the master and tool unit assemblies abut, and operative to transfer pneumatic fluid between the master unit assembly and the tool unit assembly; and
the tool unit assembly further comprises a second pneumatic pass-through conduit operative to conduct pneumatic fluid from the master unit assembly to the tool stand when the robotic tool is positioned in the tool stand;
wherein pneumatic fluid provided by the second pneumatic pass-through conduit to the tool stand is directed through a bridge conduit on the tool stand back to the first pneumatic pass-through conduit;
whereby when the robotic tool is disposed in the tool stand, pneumatic fluid is operative to pass from the master unit assembly to the tool unit assembly via the second pneumatic coupling, through the second pneumatic pass-through conduit to the tool stand, through the bridge conduit on the tool stand back to the tool unit, through the first pneumatic pass-through conduit and first pneumatic coupling to the master unit assembly, and through the master unit assembly to the decouple port of the piston to decouple; and
whereby when the robotic tool is not disposed in the tool stand, no pneumatic fluid is present at the decouple port of the piston, and the piston remains in the coupled position.

15. The tool changer of claim 14, further wherein:
the master unit assembly is operative to receive pneumatic fluid from a pneumatic fluid source on the robot; and
the master unit assembly further comprises a control valve operative to direct pneumatic fluid to the couple port of the piston to couple and operative to vent pneumatic fluid from the couple port of the piston to decouple; and further operative to direct pneumatic fluid, via the tool stand, to the decouple port of the piston to decouple and operative to vent pneumatic fluid from the decouple port of the piston, via the tool stand, to couple.

16. The tool changer of claim 15 wherein the control valve is a 4-way solenoid valve.

17. The tool changer of claim 16 wherein the control valve is a 3-way, dual solenoid valve operative to not automatically configure to couple in the absence of power.

18. The tool changer of claim 4 wherein
the tool unit assembly is operative to receive pneumatic fluid via a pneumatic fluid coupling to the tool stand when the robotic tool is disposed in the tool stand;
a decouple signal connection is formed between master unit assembly and the tool unit assembly when the master and tool units abut; and
the tool unit further comprises a decouple control valve operative to selectively direct pneumatic fluid from the tool stand to the master unit assembly via the first pneumatic coupling in response to the decoupling signal;
whereby when the robotic tool is not disposed in the tool stand, no pneumatic fluid is present at the decouple port of the piston, and the piston remains in the coupled state.

19. The tool changer of claim 18 wherein
each of the master and tool unit assemblies further comprises a second pneumatic coupling positioned to mate in pneumatic fluid flow relationship when the master and tool unit assemblies abut, and operative to transfer pneumatic fluid between the master unit assembly and the tool unit assembly; and
the tool unit further comprises a pneumatic pass-through conduit operative to conduct pneumatic fluid between the master unit assembly and the tool stand when the robotic tool is positioned in the tool stand;
wherein pneumatic fluid provided by the pneumatic pass-through conduit to the tool stand is directed through a bridge conduit on the tool stand back to the tool unit assembly via dual pneumatic fluid couplings to the tool stand;
whereby when the robotic tool is disposed in the tool stand, pneumatic fluid is operative to pass from the master unit assembly to the tool unit assembly via the second pneumatic coupling, through the pneumatic pass-through conduit to the tool stand, through the bridge conduit on the tool stand back to the tool unit assembly, and to the decouple control valve; and
whereby when the robotic tool is not disposed in the tool stand, no pneumatic fluid is present at the decouple control valve, and the piston remains in the coupled state.

20. An inherently safe method of selectively attaching a robotic tool disposed in a tool stand to a robot, wherein a master unit assembly of a tool changer is attached to the robot and a tool unit assembly of the tool changer attached to the robotic tool, and wherein one of the master and tool unit assemblies includes a coupling mechanism operative to selectively couple and decouple the master and tool unit assemblies to and from each other, the method comprising:
positioning the robot adjacent the robotic tool such that the master and tool unit assemblies abut;
utilizing power from a first source to drive the coupling mechanism to couple the master and tool unit assemblies together;
removing the robotic tool from the tool stand by operation of the robot;
returning the robotic tool to the tool stand by operation of the robot; and
utilizing power from a second source associated with the tool stand to drive the coupling mechanism to decouple the master and tool unit assemblies;
wherein when the robotic tool is not disposed in the tool stand, no power from the second source is available to drive the coupling mechanism to decouple the master and tool unit assemblies.

21. The method of claim 20 wherein the coupling mechanism comprises a pneumatically-actuated piston having a couple port and a decouple port.

22. The method of claim 20 further comprising:
receiving pneumatic fluid from a supply associated with the robot;
directing the pneumatic fluid received from the robot supply to the couple port of the piston to couple the master and tool unit assemblies together;
receiving pneumatic fluid from a supply associated with the tool stand only when the robotic tool is disposed in the tool stand; and
applying the pneumatic fluid received from the tool stand supply to the decouple port of the piston to decouple the master and tool unit assemblies.

23. The method of claim 20 further comprising:
receiving pneumatic fluid from a supply associated with the robot;
directing the pneumatic fluid received from the robot supply to the couple port of the piston to couple the master and tool unit assemblies together;
routing pneumatic fluid received from the robot supply through a pneumatic bridge conduit on the tool stand and receiving the pneumatic fluid from the bridge conduit only when the robotic tool is disposed in the tool stand; and
applying the pneumatic fluid received through the tool stand bridge conduit to the decouple port of the piston to decouple the master and tool unit assemblies.
